(19) United States
(12) Patent Application Publication
(10) Pub. No.: US 2025/0082023 A1
(43) Pub. Date: Mar. 13, 2025

(54) AEROSOL PROVISION SYSTEM

(71) Applicant: Nicoventures Trading Limited, London (GB)

(72) Inventors: Mike XIAO, London (GB); Mark POTTER, London (GB); Richard HAINES, London (GB)

(21) Appl. No.: 18/290,675

(22) PCT Filed: Jul. 6, 2022
(86) PCT No.: PCT/GB2022/051736

§ 371 Date: Jan. 19, 2024

(30) Foreign Application Priority Data
Jul. 19, 2021 (GB) 2110311.4
Jul. 19, 2021 (GB) 2110323.9
Jul. 19, 2021 (GB) 2110324.7
Jul. 19, 2021 (GB) 2110325.4

(51) Int. Cl. A24F 40/44; A24F 7/00; A24F 40/10; A24F 40/30; A24F 40/42; A24F 40/46; A24F 40/485; H05B 3/10

(52) U.S. Cl. CPC A24F 40/44; A24F 7/00; A24F 40/10; A24F 40/30; A24F 40/42; A24F 40/46; A24F 40/485; H05B 3/10

(57) ABSTRACT

An aerosol provision system including an aerosolizable material transport element for receiving aerosolizable material. The aerosolizable material transport element includes an aperture extending through a thickness of the aerosolizable material transport element. The aerosol provision system also includes a conductive member, in the form of a conductive plate or a conductive foil, which is in contact with the aerosolizable material transport element, and including a thermally conductive surface for receiving heat for transferring to the aerosolizable material transport element. The aerosolizable material transport element is in contact with the conductive member at a contact surface from the conductive member, and the contact surface is opposite the thermally conductive surface. This arrangement allows for an efficient transfer of heat across the conductive member to the aerosolizable material transport element.

### RELATED APPLICATIONS

The present application is a National Phase Entry of PCT Application PCT/GB2022/051736 filed Jul. 6, 2022, which claims priority to GB Application No. 2110311.4 filed Jul. 19, 2021, GB Application No. 2110323.9 filed Jul. 19, 2021, GB Application No. 2110324.7 filed Jul. 19, 2021 and GB Application No. 2110325.4, filed Jul. 19, 2021, each of which is hereby incorporated by reference in their entirety.

### FIELD

The present disclosure relates to aerosol provision systems such as, but not limited to, nicotine delivery systems (e.g. electronic cigarettes and the like).

### BACKGROUND

Electronic aerosol provision systems such as electronic cigarettes (e-cigarettes) generally contain aerosolizable material, such as a reservoir of fluid or liquid containing a formulation, typically but not necessarily including nicotine, or a solid material such a tobacco-based product, from which a vapor/aerosol is generated for inhalation by a user, for example through heat vaporization. Thus, an aerosol provision system will typically comprise a vaporizer, e.g. a heating element, arranged to vaporize a portion of aerosolizable material to generate a vapor.

Once a vapor has been generated, the vapor may be passed through flavoring material to add flavor to the vapor, after which the (flavored) vapor may be then delivered to a user via a mouthpiece from the aerosol provision system.

It is common for aerosol provision systems to comprise a modular assembly, often having two main functional parts, namely a control unit/body, and disposable/replaceable consumable part.

A potential drawback of existing aerosol provision systems is that of leakage of aerosolizable material from the consumable part into the control unit/body part. Such leakage can be disadvantageous, since it may interfere with an efficient operation of the aerosol provision system, and reduce the operating life of the aerosol provision system. A further potential drawback of existing aerosol provision systems is that of inefficient vaporization of the aerosolizable material therefrom.

Various approaches are therefore described herein which seek to help address or mitigate some of the issues discussed above.

### SUMMARY

According to a first aspect of certain embodiments there is provided an aerosol provision system comprising:
an aerosolizable material transport element for receiving aerosolizable material, wherein the aerosolizable material transport element comprises an aperture extending through a thickness of the aerosolizable material transport element; and
a conductive member, in contact with the aerosolizable material transport element, and comprising a thermally conductive surface for receiving heat for transferring to the aerosolizable material transport element;
wherein the aerosolizable material transport element is in contact with the conductive member at a contact surface from the conductive member, wherein the contact surface is opposite the thermally conductive surface;
wherein the conductive member comprises a conductive plate or a conductive foil.

According to a second aspect of certain embodiments there is provided a method of forming a vapor using an aerosolizable material transport element, wherein the method comprises:
receiving aerosolizable material in the aerosolizable material transport element;
receiving heat at a thermally conductive surface from a conductive member, wherein the conductive member comprises a conductive plate or a conductive foil;
transferring the heat from the conductive member to the aerosolizable material transport which is in contact with the conductive member; and
forming a vapor, from the heat transferred to the aerosolizable material transport, and from the aerosolizable material, at the aerosolizable material transport element.

Additional aspects include those embodiments as set out in the clauses recited at the end of the description as filed.

It will be appreciated that features and aspects of the invention described above in relation to the various aspects of the invention are equally applicable to, and may be combined with, embodiments of the invention according to other aspects of the invention as appropriate, and not just in the specific combinations described herein.

### BRIEF DESCRIPTION OF THE DRAWINGS

Embodiments of the invention will now be described, by way of example only, with reference to the accompanying drawings, in which:

FIG. 1A schematically represents a perspective view of an aerosol provision system, comprising a cartridge and a body, with the cartridge detached from the body, in accordance with certain embodiments of the disclosure.

FIG. 1B schematically represents a perspective view of the aerosol provision system from FIG. 1A, with a portion of the body cut away, and which shows a recess/receptacle from the body releasably accommodating at least one surface of the cartridge, in accordance with certain embodiments of the disclosure.

FIG. 1C schematically represents a perspective view of the aerosol provision system from FIG. 1A, with a portion of the body cut away, and which shows a recess/receptacle from the body releasably accommodating at least one surface of the cartridge, in accordance with certain embodiments of the disclosure.

FIG. 2A schematically represents a perspective view of the cartridge from FIGS. 1A-1C when viewed from a first end surface of the cartridge, in accordance with certain embodiments of the disclosure.

FIG. 2B schematically represents a first sectional perspective view of the cartridge from FIG. 2A, showing a first and second channel from the cartridge, and which shows a second reservoir from the cartridge, in accordance with certain embodiments of the disclosure.

FIG. 2C schematically represents a second sectional perspective view of the cartridge from FIG. 2A, showing a first and the second reservoir from the cartridge, and showing the second channel, in accordance with certain embodiments of the disclosure.

FIG. 2D schematically represents an exploded perspective view of the cartridge from FIG. 2A, showing a mouthpiece; an aerosolizable material transport element; and a conductive member; from the cartridge, in accordance with certain embodiments of the disclosure.

FIG. 3A schematically represents a third sectional perspective view of the cartridge from FIG. 2A, with added arrows illustrating air and vapor flow paths, and heat paths, in accordance with certain embodiments of the disclosure.

FIG. 3B schematically represents an enlarged sectional perspective view of the cartridge from FIG. 3A, better showing an aerosolizable material transport element from the cartridge, in accordance with certain embodiments of the disclosure.

FIG. 3C schematically represents a fourth sectional perspective view of the cartridge from FIG. 2A, with added arrows illustrating air; fluid; and vapor flow paths, in accordance with certain embodiments of the disclosure.

FIG. 3D schematically represents an exploded perspective view of a portion of the cartridge from FIG. 2A, sand which in particular shows the aerosolizable material transport element and the conductive member from the cartridge, in accordance with certain embodiments of the disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to non-combustible aerosol provision systems, which may also be referred to as aerosol provision systems, such as e-cigarettes. According to the present disclosure, a “non-combustible” aerosol provision system is one where a constituent aerosolizable material of the aerosol provision system (or component thereof) is not combusted or burned in order to facilitate delivery to a user. Aerosolizable material, which also may be referred to herein as aerosol generating material or aerosol precursor material, is material that is capable of generating aerosol, for example when heated, irradiated or energized in any other way.

Throughout the following description the term “e-cigarette” or “electronic cigarette” may sometimes be used, but it will be appreciated this term may be used interchangeably with aerosol provision system/device and electronic aerosol provision system/device. An electronic cigarette may also known as a vaping device or electronic nicotine delivery system (END), although it is noted that the presence of nicotine in the aerosolizable material is not a requirement.

In some embodiments, the non-combustible aerosol provision system is a hybrid system to generate aerosol using a combination of aerosolizable materials, one or a plurality of which may be heated. In some embodiments, the hybrid system comprises a liquid or gel aerosolizable material and a solid aerosolizable material. The solid aerosolizable material may comprise, for example, tobacco or a non-tobacco product.

Typically, the non-combustible aerosol provision system may comprise a consumable part and a device/body which is configured to releasably engage with the consumable part.

The aerosol provision system may be provided with a means for powering a vaporizer therein, and there may be provided an aerosolizable material transport element for receiving the aerosolizable material that is to be vaporized. The aerosol provision system may also be provided with a reservoir for containing aerosolizable material, and in some embodiments a further reservoir for containing flavoring material for flavoring a generated vapor from the aerosol provision system.

In some embodiments, the vaporizer may be a heater/heating element capable of interacting with the aerosolizable material so as to release one or more volatiles from the aerosolizable material to form a vapor/aerosol. In some embodiments, the vaporizer is capable of generating an aerosol from the aerosolizable material without heating. For example, the vaporizer may be capable of generating a vapor/aerosol from the aerosolizable material without applying heat thereto, for example via one or more of vibrational, mechanical, pressurisation or electrostatic means.

In some embodiments, the substance to be delivered may be an aerosolizable material which may comprise an active constituent, a carrier constituent and optionally one or more other functional constituents.

The active constituent may comprise one or more physiologically and/or olfactory active constituents which are included in the aerosolizable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, theine, a vitamin such as B6 or B12 or C, melatonin, a cannabinoid, or a constituent, derivative, or combinations thereof. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, or mixtures thereof.

In some embodiments, the active constituent is an olfactory active constituent and may be selected from a “flavor” and/or “flavorant” which, where local regulations permit, may be used to create a desired taste, aroma or other somatosensorial sensation in a product for adult consumers. In some instances such constituents may be referred to as flavors, flavorants, flavoring material, cooling agents, heating agents, and/or sweetening agents. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavoring material (flavor) may comprise menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, coloring agents, preservatives, binders, fillers, stabilizers, and/or antioxidants.

As noted above, aerosol provision systems (e-cigarettes) often comprise a modular assembly including both a reusable part (body/device) and a replaceable consumable (cartridge) part. Devices conforming to this type of two-part modular configuration may generally be referred to as two-part devices. It is also common for electronic cigarettes to have a generally elongate shape. For the sake of providing a concrete example, certain embodiments of the disclosure described herein comprise this kind of generally elongate two-part device employing consumable parts. However, it will be appreciated the underlying principles described herein may equally be adopted for other electronic cigarette configurations, for example modular devices comprising more than two parts, as devices conforming to other overall shapes, for example based on so-called box-mod high performance devices that typically have a more boxy shape.

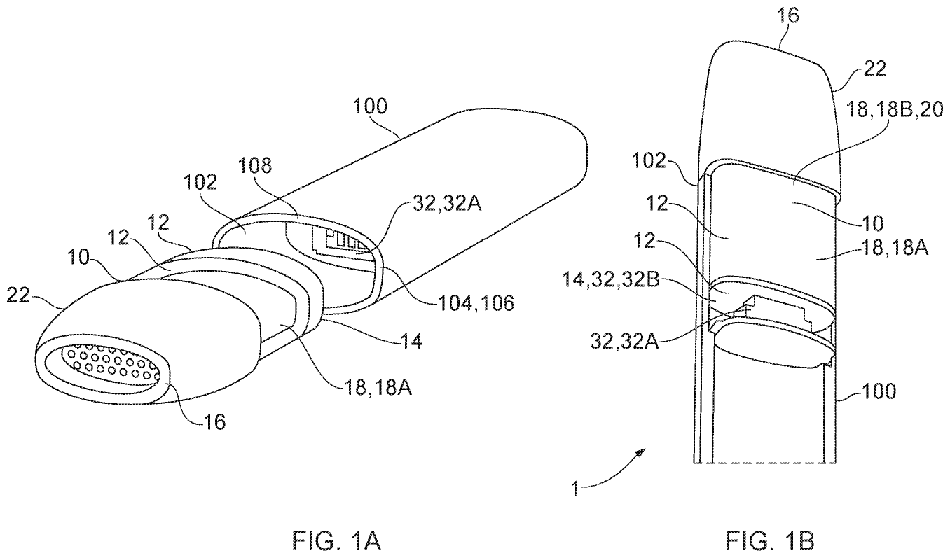

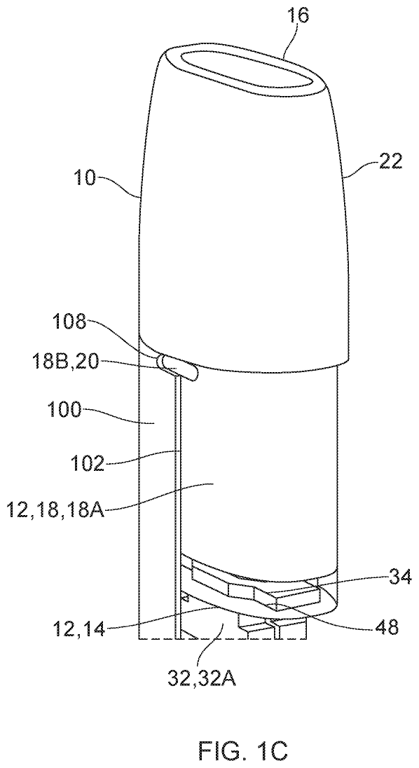

From the forgoing therefore, and with initial reference to FIGS. 1A-1C, in accordance with some embodiments provided herein is an aerosol provision system 1 comprising a cartridge 10 and a body 100. The body may comprise a recess/receptacle 102 for releasably accommodating at least one surface 12 of the cartridge 10, potentially via a friction-fit, wherein the at least one surface 12 of the cartridge 10 is devoid of any fluid inlet for delivering fluid into the cartridge 10. In this way, since the at least one surface 12 of the cartridge 10 is devoid of any fluid inlet for delivering fluid into the cartridge 10, this helps to inhibit fluid from leaking from the cartridge 10 into the body 100 when the cartridge 10 is accommodated in the body 100 (e.g. with reference to the embodiment shown in FIGS. 1A-1C, in the position of FIG. 1B).

In accordance with some of the above embodiments, the cartridge 10 may comprise a first end surface 14 which is configured to be releasably accommodated in the recess 102, and a second end surface 16 which is opposite the first end surface 14 and which is configured to be outside of the recess 102 when the first end surface 14 is releasably accommodated in the recess 102. In some embodiments thereof, the at least one surface 12 may then comprise the first end surface 14 (e.g. as shown in the embodiments from FIGS. 1A-1C, where the first end surface 14 is devoid of any fluid inlet for delivering fluid into the cartridge 10).

For providing added security to the cartridge 10 when it is in use with the body 100, the cartridge may comprise a plurality of side surfaces 18 which extend between the first end surface 14 and the second end surface 16, wherein the at least one surface 12 comprises a first portion 18A of the plurality of side surfaces 18. In that respect, by virtue of the at least one surface 12 comprising a first portion 18A of the plurality of side surfaces 18, this helps to better accommodate more of the cartridge 10 in the body when the cartridge is in use. In this respect as well therefore, the first portion 18A of the plurality of side surfaces 18 is then devoid of any fluid inlet for delivering fluid into the cartridge 10, which further helps to inhibit fluid from leaking from the cartridge 10 into the body 100 (e.g. as shown in the embodiments from FIGS. 1A-1C, where the first portion 18A of the plurality of side surfaces 18 is devoid of any fluid inlet for delivering fluid into the cartridge 10).

Where the plurality of side surfaces 18 are present, in accordance with some embodiments thereof, such as the embodiment shown in FIGS. 1A-1C, the plurality of side surfaces 18 may comprise a second portion 18B which is configured to be outside of the recess 102 when the first end surface 14 is releasably accommodated in the recess 102. Such a second portion 18B is best shown illustratively with reference to the embodiment as illustrated in FIG. 1C. For such a second portion 18B, in some embodiments thereof, the second portion 18B may comprise at least one air inlet 20 (or more than one air inlet) for delivering air into the cartridge 10. As will be described, each such air inlet is then configured to allow air to pass through the cartridge, to pick up a vapor of aerosolizable material for ultimate inhalation by a user of the cartridge 10. In embodiments where a plurality of air inlets are employed, in accordance with some embodiments thereof, such as the embodiment shown in FIG. 1C, the plurality of air inlets 20 may comprise a pair of air inlets located on opposing side surfaces from the plurality of side surfaces 18.

Staying with the cartridge 10, in some embodiments, to better allow a user to inhale any generated vapor from the cartridge 10, the cartridge may comprise a mouthpiece 22. The mouthpiece may comprise a part of the second portion 18B and may comprise the second end surface 16 of the cartridge, for instance as shown in the embodiment of cartridge from FIGS. 1A-1C. In accordance with some embodiments where the mouthpiece 22 is employed, any provided air inlet(s) from the cartridge 10 may be located between the mouthpiece 22 and the first end surface 14. In some particular embodiments thereof, as shown in the embodiment of cartridge from FIG. 1C, each air inlet may be located adjacent to the mouthpiece 22.

Staying with this embodiment from FIG. 1C, in accordance with some embodiments of aerosol provision system 1 described herein, the body 100 may comprise a shroud 104 which defines the recess 102, wherein an end 106 of the shroud 104 comprises at least one (or a plurality of) recessed portion 108, wherein each recessed portion 108 is configured to align with an air inlet 20 from the cartridge 10 when the at least one surface 12 of the cartridge 10 is releasably accommodated in the recess 102. In this way, the recessed portion 108 may better shield the periphery of the air inlet 20 during use of the cartridge 10 from accidental damage, which might otherwise affect the performance of the aerosol provision system 1. In a very particular embodiment, and where the mouthpiece 22 is employed, the mouthpiece 22 may be configured to be adjacent to the at least one recessed portion 108 when the at least one surface 12 of the cartridge 10 is releasably accommodated in the recess 102. In such particular embodiments, by having the air inlets 20 positioned in this way relative to the mouthpiece 22 and the at least one recessed portion 108, this better ensures a convenient fit of the mouthpiece 22 relative to the at least one recessed portion 108 in a way such that the air inlets 20 are located outside the recess 102 and in a way that better shields the periphery of each air inlet 20 from accidental damage during use of the cartridge 10. Conveniently as well, locating the air inlets 20 in this position better ensures that the air inlets 20 will not be accidentally covered by the user with their hand during their holding of the body 100, noting the user is less likely to grip the body at the region proximal the mouthpiece 22. Accordingly, locating each air inlet 20 in this position again better ensures that the air inlets 22 remain unblocked, and thus fully operational, during use of the aerosol provision system 1.

Appreciating the foregoing therefore, and in accordance with some embodiments described herein, there may also be provided an aerosol provision system 1 comprising a cartridge 10 comprising the mouthpiece 22; and a body comprising a recess for releasably accommodating the at least one surface 12 of the cartridge 10, wherein the body comprises the shroud 104 which defines the recess 102, wherein an end 106 of the shroud 104 comprises the at least one recessed portion 108, wherein each recessed portion 108 is configured to align with an air inlet 20 from the cartridge 10 when the at least one surface 12 of the cartridge 10 is releasably accommodated in the recess 102. In some embodiments thereof, the mouthpiece 22 may be then configured to be adjacent to the at least one recessed portion 108 when the at least one surface 12 of the cartridge 10 is releasably accommodated in the recess 102.

In so far as any mouthpiece may be employed, it may be appreciated that this may conveniently act to help engage with the recess when the cartridge 10 is engaged with the body 100. In this respect as well, it may be also appreciated that the cartridge and corresponding recess/receptacle may employ a non-circular, and/or elongate, cross section for facilitating easier alignment of the cartridge with respect to the recess/receptacle. Such shapes may also assist with providing for a mouthpiece shape, potentially also via the use of inclined side surfaces, whose shape is thus particularly well configured for wrapping a user's lips around, thus allowing the user to more effectively seal their lips around any orifice at the end of the mouthpiece through which vaporized aerososliable material may be delivered into the user's mouth.

At least in accordance with some embodiments as well, it may be appreciated that an outer surface of the mouthpiece, such as of the inclined side surface of the mouthpiece, may in accordance with some embodiments be opaque. This may facilitate the user in not being able to view the internal contents of the cartridge in use (as shown in the embodiments of the Figures), such as any plumes of vapor forming inside the cartridge 100, which otherwise might cause concern for some potential users. In this respect as well, and in accordance with some embodiments, such as shown in the Figures, the mouthpiece and/or inclined side surfaces may be black and/or matte to better allow for any marks on the mouthpiece (such as lipstick or some other stain) to be more easily removed and/or go unnoticed.

From the foregoing remarks therefore, it may be seen that a further aspect of the present disclosure is in respect of the particularly effective geometry of the mouthpiece herein described, which may appreciably be used with any type of aerosolizable material, such as a solid aerosolizable material (e.g. including potentially tobacco) and/or a liquid aerosolizable material (and in this latter case, then potentially using any of the herein described aerosolizable material transport element 34).

In a similar vein, and appreciating the above, in accordance with some embodiments described herein, there may also be provided a cartridge 10 for use in an aerosol provision system 1, wherein the cartridge 10 comprises: a first end surface 14 which is devoid of any fluid inlet for delivering fluid into the cartridge 10; a second end surface 16 which is opposite the first end surface 14; a plurality of side surfaces 18 which extend between the first end surface 14 and the second end surface 16, wherein the plurality of side surfaces 18 comprises at least one air inlet 20 for delivering air into the cartridge; and a mouthpiece 22; wherein each air inlet 20 is located adjacent to the mouthpiece 22, and is located between the mouthpiece 22 and the first end surface 14.

In accordance with at least some of the above embodiments, the at least one surface 12 of the cartridge 10 may be devoid of any fluid inlet for delivering fluid into the cartridge 10, such to help inhibit leakage of aerosolizable material from the cartridge 10 into the body. That being the case, in such embodiments, the fluid inlet may comprise an air inlet 20 such to better inhibit any residual moisture from any air passing through the air inlet 20 from passing through to the body 100, and/or may comprise an inlet for aerosolizable material (such to better prevent any vaporized aerosolizable material reaching the body 100).

From the foregoing therefore, the above embodiments describe embodiments which better help inhibit leakage of aerosolizable material from the cartridge 10 into the body 100.

Turning to other aspects of the aerosols provisions systems 1 described herein, in accordance with some embodiments thereof, the cartridge therefrom may be provided with a first reservoir 30 for containing aerosolizable material, and the aerosol provision system 1 may be further provided in some embodiments with a vaporizer 32 for vaporizing aerosolizable material from the first reservoir 30. In some embodiments thereof, and in general terms, air may be then configured to pass through the air inlet 20, past the vaporizer 32 where a vapor of aerosolized material may then be formed, and ultimately out from the mouthpiece 22 for inhalation by a user during use of the aerosol provision system 1, as will be described.

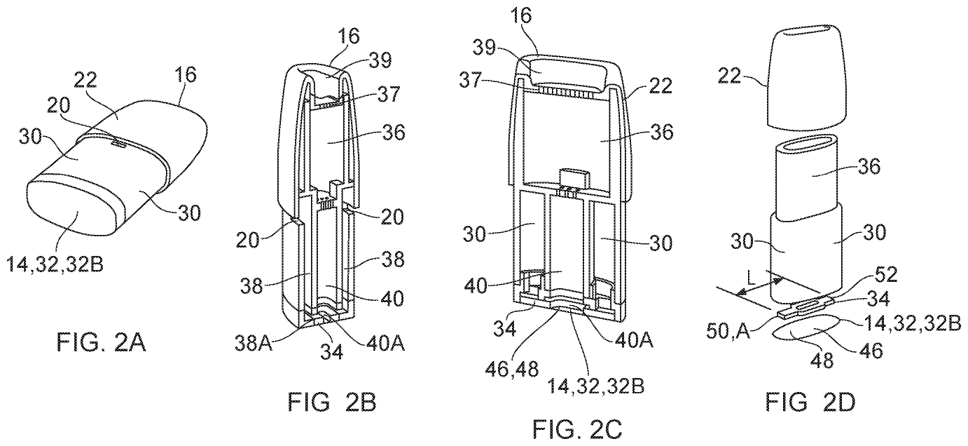

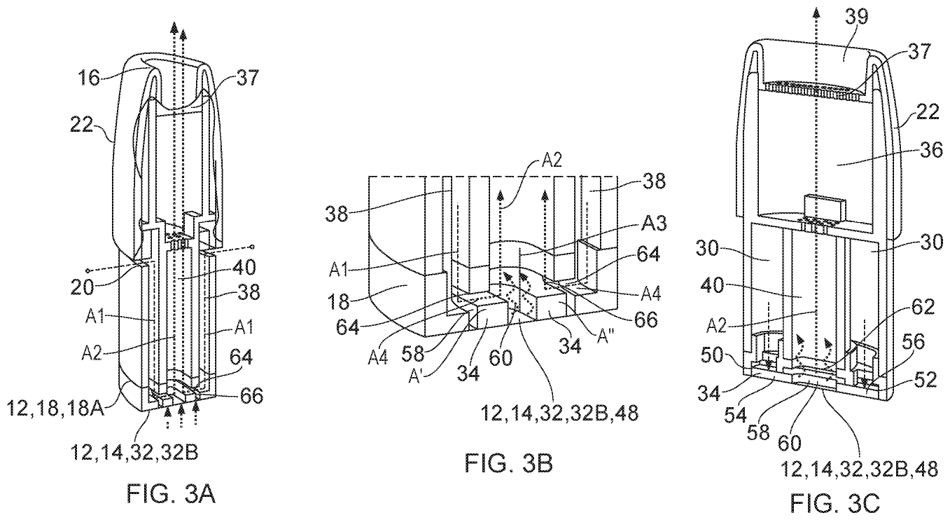

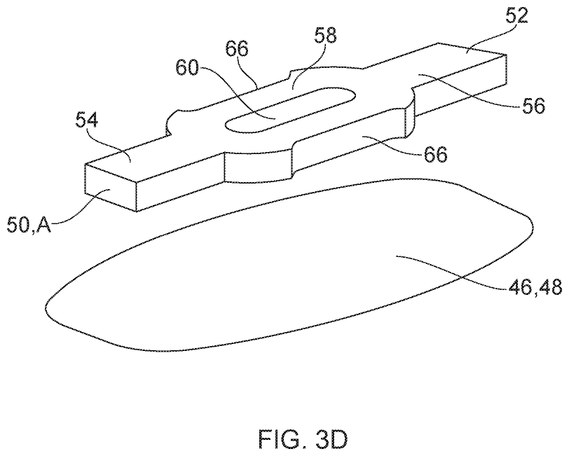

In accordance with some more specific embodiments, such as the embodiments shown in FIGS. 2A-3D, the cartridge 10 may comprise an aerosolizable material transport element 34 for receiving aerosolizable material from the first reservoir 30, wherein the vaporizer 32 is configured to vaporize aerosolizable material in the aerosolizable material transport element 34.

To add flavoring material to any vapor that is provided to the user, in accordance with some embodiments, the cartridge in accordance with some embodiments may be further provided with a second reservoir 36 for containing flavoring material. Where such a second reservoir 36 is employed, the second reservoir may be located upstream of any provided vaporizer 32 (such to deliver the flavoring material prior to any aerosolizable material being vaporized), or in accordance with some embodiments may be configured to add the flavoring material to the aerosolizable material from the first reservoir 30 prior to it being vaporized by the vaporizer 32. In other embodiments however, such as that shown in FIGS. 2A-3D, the second reservoir 36 may be configured to receive vaporized aerosolizable material from the vaporizer 32. As to the spatial arrangement of any provided second reservoir 36 relative to the first reservoir 30, it will be appreciated that the second reservoir 36 may be located in a number of different locations in the cartridge. However, in accordance with some embodiments, to help provide for a compact arrangement of the cartridge 10, the first reservoir 30 may be located between the second reservoir 36 and the first end surface 14. Equally, and or alternatively, in some embodiments the second reservoir 36 may be surrounded by the mouthpiece 22 (where employed), and/or may be configured to deliver vaporized, flavored, aerosolizable material out from an outlet 37 from the cartridge 10/aerosol provision system 1. Such an outlet 37, in some very particular embodiments, may be located in the second end surface, or may be located in a recess/orifice 39 extending from the second end surface 16 (as in the embodiment shown in FIGS. 2A-3D). For the avoidance of any doubt however, it will be appreciated that any provided outlet 37 may be located in a variety of different locations on the cartridge 10, depending on the exact shape/configuration of the cartridge 10 which is employed.

Equally, where any second reservoir 36 is employed, it will be further appreciated that the second reservoir 36 may comprise any combination of flavoring material(s), such as any of those described previously. Though in accordance with some particular embodiments, the flavoring material may comprise tobacco and/or nicotine.

Moving away from any provided second reservoir 36, and turning to how air/vapor may be directed through the cartridge 10 in use, in accordance with some embodiments, such as that shown in FIGS. 2A-3D, the cartridge 10 may comprise a first channel 38 for receiving air from an air inlet(s) 20 of the cartridge 10. The cartridge 10 may then comprise a second channel 40, which is located downstream of the first channel 38, and which is configured to receive vaporized aerosolizable material from the vaporizer 32 (as will be described). In some embodiments thereof, to help provide for a compact arrangement of the cartridge 10, the first channel 38 may be parallel to the second channel 40, and the first channel 38 may be located outside of the second channel 40. Equally and/or alternatively, in some embodiments, the first channel 38 may be located closer to the plurality of side surfaces 18 than the second channel 40 is located to the plurality of side surfaces 18.

With respect to embodiments where any first channel 38 is parallel to the second channel 40, in these embodiments and potentially other embodiments, air may be configured to flow in a first direction A1 along the first channel 38, and vaporized aerosolizable material from the vaporizer 32 may be configured to flow in a second direction A2 along the second channel 40, wherein the second direction A2 is opposite to the first direction A1. These first and second directions A1 and A2 are shown, for example, in the embodiment of cartridge shown in FIGS. 3A-3C. In such embodiments, the change in direction from the first direction A1 to the second direction A2 may increase the turbidity of the air passing over the vaporizer 32 and/or any provided aerosolizable material transport element 34, which may each/both be located at a (downstream) end 38A of the first channel 38 and at an (upstream) end 40A of the second channel 40. Such increased turbidity may then assist with a better formation and passage of vapor through the second channel 40 along the second direction A2.

Staying with the geometry of the second channel 40, in accordance with some space-efficient embodiments, the second channel 40 may be located between the first end surface 14 and any provided second reservoir 36. Equally/alternatively, the end of the second channel 40A may be located adjacent to any provided aerosolizable material transport element 34 from the cartridge 10.

Turning to the features of any provided vaporizer 32 and/or aerosolizable material transport element 34, a purpose of these features is to vaporize aerosolizable material deriving from the first reservoir 30 to create a vaporized aerosolizable material which may be imparted to the user during use of the aerosol provision system 1. In that respect, any generated vaporized aerosolizable material may pass along the second channel 40, and then via the second reservoir and out from the outlet 37.

Notionally, the vaporizer 32 may take a variety of different forms, such that the vaporizer may be configured to generate a vapor/aerosol from the aerosolizable material by applying heat thereto (for instance via a heater/heating element), or by not applying heat thereto (for example via one or more of vibrational, mechanical, pressurisation or electrostatic means as described previously).

That being said, in accordance with some embodiments, the vaporizer 32 may comprise a heating element 32A located in the body 100, and may be configured such that the vaporizer 32 is at least partially located in the body 100 and is at least partially located in the cartridge 10, as shown for instance in the embodiments from the Figures. In accordance with some particular embodiments thereof, the cartridge 10 may then comprise an thermally conductive surface 32B for receiving heat from the heating element 32A located in the body 100, which may be an exterior, thermally, conductive surface; wherein the thermally conductive surface 32B forms part of the vaporizer 32.

In accordance with the above described embodiment therefore, and also the particular embodiment shown in the Figures, the vaporizer 32 may therefore be formed of two portions—a first, heating element, portion 32A located in the body 100; and a second portion in the form of the thermally conductive surface 32B located in the cartridge 10. In this way, the thermally conductive surface 32B is configured to contact the heating element 32A when the at least one surface 12 of the cartridge 10 is releasably accommodated in the recess 102 from the body 100. The provision of this two portion vaporizer 32 provides for a number of advantages, not least in terms of helping to keep the at least one surface 12 of the cartridge 10 free of fluid inlets such to help inhibit leakage of aerosolizable material from the cartridge 10 into the body 100. Furthermore, the splitting of the vaporizer 32 between the cartridge 10 and the body portion 100 provides an added safety feature of preventing the vaporizer 32 from operating when the cartridge 10 is separated from the body 100. By also locating some of the vaporizer 32 in the body 100, this also helps to reduce the number of components in the cartridge 10, which is helpful noting the cartridge in some embodiments may be configured to be consumable/disposable.

Appreciating the foregoing, and where the (exterior) thermally conductive surface 32B is employed, in accordance with some embodiments thereof, the thermally conductive surface 32B may form part of a conductive member 46 (which in some particular embodiments may comprise a conductive plate or a conductive foil) from the cartridge 10, wherein the aerosolizable material transport element 34 is in contact with the conductive member 46. In this way, when the heating element 32A contacts the thermally conductive surface 32B, heat from the heating element 32A may be then passed through the thermally conductive surface 32B, and through the conductive member 46, and transmitted to the aerosolizable material transport element 34. Such an embodiment is shown in the embodiment of FIG. 1C. Put differently, in accordance with some of the above embodiments, and notionally other embodiments, the aerosolizable material transport element 34 may be in contact with the conductive member 46 at a contact surface 48 from the conductive member 46, wherein the contact surface 48 is opposite, and/or parallel to, the (exterior) thermally conductive surface 32B. In some embodiments, such as those shown in the Figures, at least one of the contact surface 48 and a corresponding surface from the aerosolizable material transport element 34 which contacts the contact surface 48, may be flat.

As alluded to briefly above, the exact shape of any provided conductive member 46 may vary depending on its application in any provided aerosol provision system 1. Though in accordance with some particular embodiments, the conductive member 46 may comprise a conductive plate or a conductive foil, and may be made of a thermally conductive material, such as (but not limited to) metal. Equally, where the conductive member 46 is employed, in accordance with some embodiments the conductive member 46 may define the first end surface 14 of cartridge 10, as is the case in the embodiments of cartridge 10 shown in the Figures. Purely for the sake of completeness, it is envisaged that the conductive member 46 may be attached to the cartridge 10, and/or attached the aerosolizable material transport element 34. In that respect, and in accordance with some particular embodiments for instance, to better secure the conductive member 46 in place during use, the conductive member 46 may in accordance with some particular embodiments be attached via at least one a crimping action, an adhesive, or a mechanical fastening means, to either the cartridge 10 and/or the aerosolizable material transport element 34.

As noted above, in accordance with some embodiments, the conductive member 46 may comprise a conductive plate or a conductive foil. In this way, this may allow for the conductive member 46 be made particularly thin, which may assist with better ensuring an efficient transfer of heat across the conductive member 46. In that respect, and in accordance with some particular embodiments, the thickness of any such conductive member 46 may be no more than 5 mm. In other additional/alternative embodiments, to best balance between providing a conductive member 46 which is particularly efficient at transferring heat across its thickness, yet thick enough to better withstand any accidental perforation of the thickness of the conductive member 46, the thickness of any such conductive member 46 may be between 0.5 mm and 5 mm, or between 1 mm and 5 mm.

In terms of the exact placement of the thermally conductive surface 32B (and/or conductive member 46), in a particularly compact and space efficient embodiment, the second channel 40 may be located between any provided second reservoir 36 and the thermally conductive surface 32B (conductive member 46).

From the foregoing therefore, the above describes particular embodiments of aerosol provision system which employs a vaporizer 32 split between the cartridge 10 and the body portion 100. That being the case, an in accordance with some more general embodiments, the above disclosure may provide for a cartridge 10 for use in an aerosol provision system 1 comprising the cartridge 10 and a body 100, wherein the cartridge 10 comprises an exterior, thermally conductive, surface 32B for receiving heat from a heating element 32A located in the body 100.

Equally, and in a general sense, the above disclosure may also provide for an aerosol provision system 1 comprising: a cartridge 10, and a body 100, wherein the cartridge 10 comprises an exterior, thermally conductive, surface 32B for receiving heat from a heating element 32A located in the body 100.

Moving away from the vaporizer 32, in accordance with some embodiments, the herein described aerosol provision system 1 may be provided with the aerosolizable material transport element 34 for receiving aerosolizable material, such as the aerosolizable material from the first reservoir 30.

In general terms, the structure and composition of the aerosolizable material transport element 34 (also called a wick) may be anything which can appropriately draw the aerosolizable material to a position where it can be vaporized by the vaporizer 32 during use of the aerosol provision system. In that respect therefore, in accordance with some embodiments, the aerosolizable material transport element 34 may comprise a porous material, a fibrous material, and/or a solid material. In some embodiments, the aerosolizable material transport element 34 may be made of cotton, or could be made of a ceramic material. Thus appreciating the foregoing, and at a general level, it will be appreciated the specific structure and composition of the aerosolizable material transport element may be varied to best cater for any intended application of the aerosol provision system 1.

The above being said, in accordance with some embodiments described herein, there may be provided an aerosolizable material transport element 34 having a particular geometry, such as (but not limited to) the geometry shown in the embodiments of cartridge 10 from the Figures. Specifically therefore, and as will be described, there may be provided an aerosolizable material transport element 34 for use in an aerosol provision cartridge 10 or aerosol provision system 1, wherein the aerosolizable material transport element 34 comprises a length L extending between a first end 50 of the aerosolizable material transport element 34 and a second end 52 of the aerosolizable material transport element. In some embodiments thereof, the cross sectional area A of the aerosolizable material transport element 34 (which is orthogonal to the length L) may be configured to change along the length L of the aerosolizable material transport element 34. Such an embodiment of aerosolizable material transport 34 element is best shown, for example, with reference to the embodiment from FIG. 2D where such an aerosolizable material transport 34 element is employed.

With respect to such an aerosolizable material transport element 34, where the cross sectional area A of the aerosolizable material transport element 34 changes along the length L of the aerosolizable material transport element 34, this provides for an aerosolizable material transport element 34 which can better, and more efficiently, direct aerosolizable material therein from a position next to the first reservoir 30 to a position more proximal the vaporizer 32 where the aerosolizable material can then be vaporized by the vaporizer 32. For the sake of completeness, in respect of the cross sectional area A, in cases where the aerosolizable material transport element 34 splits into multiple cross sectional areas at a given position along the length L of the aerosolizable material transport element 34, the cross sectional area A in this axial position along the length L is to be interpreted as the sum of the multiple cross sectional areas in this axial position (for instance the sum of cross sectional area A′ and cross sectional area A″ as shown in the embodiment of FIG. 3B in respect of an aerosolizable material transport element 34 which splits into two at axial positions along the length L of the aerosolizable material transport element 34).

Appreciating the above, and in accordance with some embodiments thereof, and other embodiments of aerosolizable material transport element 34 described herein, any provided aerosolizable material transport element may comprise a first leg portion 54 extending from the first end 50, and a second leg portion 56 extending from the second end 52, and a central body portion 58 located between the first leg portion 54 and the second leg portion 56. In some embodiments thereof, the central body portion may then comprise an aperture 60 extending through a thickness of the aerosolizable material transport element 34. A first function of the aperture 60 is to increase the exposed surface area of the aerosolizable material transport element 34 to thus increase the amount of vaporized aerosolizable material which can be generated off from the aerosolizable material transport element 34. This increased surface area, for a given size of aerosolizable material transport element 34, may therefore also be effective in allowing for a smaller size of aerosolizable material transport element 34 to be used than would be otherwise possible. A second function of the aperture is to allow heat from the vaporizer 32 (such as the exterior, thermally conductive, surface 32B) to better pass into the second channel 40 and around the vicinity of the aerosolizable material transport element 34 to better ensure it is suitably heated for heating aerosolizable material. In accordance with such embodiments, the introduction of the aperture 60 may also conveniently assist with the better directing of vaporized aerosolizable material from the aerosolizable material transport element 34 into, and along, the second channel 40 towards the outlet 37. This directing effect can be seen with reference to the wavy arrows shown in FIGS. 3B and 3C, which are located in the proximity of the aperture 60 and which extend towards the second channel 40. In a particular embodiment where the above effects may be additionally exhibited, any provided aperture 60 may extend through a thickness of the aerosolizable material transport element 34 in a direction A3 which is perpendicular or orthogonal to the length L of the aerosolizable material transport element 34, and/or which is parallel to the first direction A1; and/or which is parallel to the second direction A2.

To help provide a more consistent formation of vaporized aerosolizable material around any provided aperture 60, in accordance with some embodiments, the aperture 60 may in accordance with some particular embodiments be cylindrical, and/or comprise a uniform cross section through the thickness of the aerosolizable material transport element 34.

In accordance with some embodiments, such as the embodiments shown in the Figures, the conductive member 46 (where employed) may cover an end of the aperture 60, such to better ensure that any heat from the conductive member 46 is funneled up through the aperture 60, such that to better relay this heat into and around the aerosolizable material transport element 34 and into the second channel 40.

Moving away from any provided aperture 60 in the aerosolizable material transport element 34, in accordance with some embodiments, each leg portion 54; 56 of the aerosolizable material transport element 34 may be configured to be in fluid communication with the first reservoir 30 for receiving aerosolizable material from the first reservoir 30. Such an embodiment is shown in the embodiment illustrated in FIG. 3C. In such embodiments therefore, aerosolizable material from the first reservoir 30 may be effectively encouraged to pass from each leg portion 54; 56 to the central body portion 58 of the aerosolizable material transport element 34.

Tying in with the above, and in accordance with some additional/alternative embodiments, the first channel 38 may comprise at least one orifice 64 in fluid communication with the second channel 40, wherein each orifice 64 is adjacent the aerosolizable material transport element 34, and/or more specifically adjacent the central body portion 58 of the aerosolizable material transport element (where the central body portion 58 is employed). In this way, air passing from the first channel through the orifice 64 may immediately impinge the aerosolizable material transport element, such to maximise the extent of vapor being delivered into the air which is then delivered to the second channel 40.

In this respect as well, and to better locate the aerosolizable material transport element 34 next to each orifice 64 (and to better prevent the aerosolizable material transport element 34 from moving laterally in use), and to help with the vaporization of aerosolizable material from the aerosolizable material transport element 34, in accordance with some embodiments, the aerosolizable material transport element 34 (or its central body portion 58, in some more particular embodiments) may comprise an indented portion 66, for each respective orifice 64, which is located adjacent its respective orifice 64, as shown for instance in the embodiment from FIG. 3B. In that respect, by virtue of each indented portion 66 creating a portion of reduced width in the aerosolizable material transport element 34 where the indented portion 66 is located, this has surprisingly been found to increase the efficiency of the aerosolizable material transport element 34 to vaporize aerosolizable material therefrom. In that respect as well, by virtue of the increased exposed surface area of the aerosolizable material transport element 34 as created by each indented portion 66, this may serve to increase the amount of vaporized aerosolizable material which can be generated off from the aerosolizable material transport element 34. This increased surface area, for a given size of aerosolizable material transport element 34 (like with the provision of any aperture 60, where present), may therefore also be effective in allowing for a smaller size of aerosolizable material transport element 34 to be used than would be otherwise possible.

In accordance with embodiments where more than indented portion 66 (orifice 64) is employed, in accordance with some particular embodiments thereof, there may be provided a first indented portion 66 located on a first side of the aerosolizable material transport element 34, and a second indented portion 66 located on a second side of the aerosolizable material transport element 34, wherein the first side is opposite the second side, as shown for instance in the embodiment of FIG. 3B. In accordance with some very particular embodiments, the first and second sides of the aerosolizable material transport element 34 may be first and second sides of the central body portion 58, again as shown in the particular embodiment of FIG. 3B. Put differently, in accordance with some embodiments, the first and second sides of the aerosolizable material transport element 34 may be located adjacent to a respect first orifice 64 and a second orifice 64 from the at least one orifice 64.

Staying with the orifice(s) 64, in accordance with some embodiments, each orifice 64 may extend in a direction A4 between the first channel 38 and the second channel 40, which is orthogonal to the first direction A1 and the second direction A2. This change of direction may assist with increasing the turbidity of the air passing over the vaporizer 32 and/or any the aerosolizable material transport element 34, to in turn better assist with a better formation and passage of vapor through the second channel 40 along the second direction A2. Equally, and in accordance with some embodiments, each orifice 64 may extend in a direction A4 which is orthogonal to the length L of the aerosolizable material transport element. In this way, the control of air and aerosolizable material can be more efficiently spaced inside the cartridge 10, and notionally additionally allows for a slender/thin width for the aerosolizable material transport element 34, such as illustrated in the embodiments of cartridge 10 shown in the Figures.

Appreciating the foregoing therefore, it can be seen that the above embodiments provide for unique designs of aerosolizable material transport element 34, which are both efficient, and additionally well suited for use in an aerosol provision cartridge 10 and/or aerosol provision systems 1. Indeed, and purely for the avoidance of any doubt, where any of the above described aerosolizable material transport element 34 is employed, it is envisaged that this may be employed in any of the herein described cartridges 10 or aerosol provision systems 1.

Accordingly, there has also been described an aerosolizable material transport element for use in an aerosol provision system,
wherein the aerosolizable material transport element comprises a length extending between a first end of the aerosolizable material transport element and a second end of the aerosolizable material transport element,
wherein the cross sectional area of the aerosolizable material transport element changes along the length of the aerosolizable material transport element;
wherein the aerosolizable material transport element comprises a first leg portion extending from the first end, and a second leg portion extending from the second end, and a central body portion located between the first leg portion and the second leg portion;
wherein the central body portion comprises an aperture extending through a thickness of the aerosolizable material transport element; and
wherein the aerosolizable material transport element comprises at least one indented portion.

There has also been described a method of forming a vapor using an aerosolizable material transport element, wherein the method comprises:
receiving aerosolizable material at a first end and a second end of the aerosolizable material transport element;
passing air over at least one indented portion of the aerosolizable material transport element; and
forming a vapor, from the aerosolizable material and the air, at an aperture from a central body portion of the aerosolizable material transport element, wherein the central body portion is located between the first end and the second end.

There has also been described an aerosol provision cartridge comprising:
an aerosolizable material transport element for receiving aerosolizable material;
a first channel for receiving air from an air inlet of the cartridge; wherein the first channel comprises at least one orifice, wherein each orifice is adjacent the aerosolizable material transport element;
wherein the aerosolizable material transport element comprises an indented portion, for each respective orifice from the first channel, which is located adjacent its respective orifice from the first channel.

There has also been described an aerosol provision system comprising:
an aerosolizable material transport element for receiving aerosolizable material;
a first channel for receiving air from an air inlet of the aerosol provision system; wherein the first channel comprises at least one orifice, wherein each orifice is adjacent the aerosolizable material transport element;
wherein the aerosolizable material transport element comprises an indented portion, for each respective orifice from the first channel, which is located adjacent its respective orifice from the first channel.

There has also been described a method of forming a vapor, wherein the method comprises:
receiving aerosolizable material in an aerosolizable material transport element;
receiving air at an air inlet;
passing the air, from the air inlet, through a first channel to at least one orifice, to an aerosolizable material transport element, wherein the air passes through the at least one orifice and over at least one indented portion from the aerosolizable material transport element; and
forming a vapor, at the aerosolizable material transport element, from the aerosolizable material and the air;
wherein each orifice is adjacent the aerosolizable material transport element.

There has also been described an aerosol provision cartridge comprising:
an aerosolizable material transport element for receiving aerosolizable material; wherein the aerosolizable material transport element comprises a first leg portion extending from a first end of the aerosolizable material transport element, and a second leg portion extending from a second end of the aerosolizable material transport element, and a central body portion located between the first leg portion and the second leg portion;
a first channel for receiving air from an air inlet of the cartridge; wherein the first channel comprises at least one orifice, wherein each orifice is adjacent the central body portion of the aerosolizable material transport element.

There has also been described an aerosol provision system comprising:
an aerosolizable material transport element for receiving aerosolizable material; wherein the aerosolizable material transport element comprises a first leg portion extending from a first end of the aerosolizable material transport element, and a second leg portion extending from a second end of the aerosolizable material transport element, and a central body portion located between the first leg portion and the second leg portion;
a first channel for receiving air from an air inlet of the aerosol provision system; wherein the first channel comprises at least one orifice, wherein each orifice is adjacent the central body portion of the aerosolizable material transport element.

There has also been described a method of forming a vapor, wherein the method comprises:
receiving aerosolizable material at a first portion and a second portion of an aerosolizable material transport element;
receiving air at an air inlet;
passing the air, from the air inlet, through a first channel to at least one orifice, to the aerosolizable material transport element, wherein the air passes through the at least one orifice and over a central body portion from the aerosolizable material transport element, wherein the central body portion is located between the first portion and the second portion; and
forming a vapor, at the central body portion from the aerosolizable material transport element, from the aerosolizable material and the air;
wherein each orifice is adjacent the central body portion of the aerosolizable material transport element.

There has also been described an aerosol provision system comprising:
an aerosolizable material transport element for receiving aerosolizable material, wherein the aerosolizable material transport element comprises an aperture extending through a thickness of the aerosolizable material transport element; and
a conductive member, in contact with the aerosolizable material transport element, and comprising a thermally conductive surface for receiving heat for transferring to the aerosolizable material transport element;
wherein the aerosolizable material transport element is in contact with the conductive member at a contact surface from the conductive member, wherein the contact surface is opposite the thermally conductive surface;
wherein the conductive member comprises a conductive plate or a conductive foil.

There has also been described a method of forming a vapor using an aerosolizable material transport element, wherein the method comprises:
receiving aerosolizable material in the aerosolizable material transport element;
receiving heat at a thermally conductive surface from a conductive member, wherein the conductive member comprises a conductive plate or a conductive foil;
transferring the heat from the conductive member to the aerosolizable material transport which is in contact with the conductive member; and
forming a vapor, from the heat transferred to the aerosolizable material transport, and from the aerosolizable material, at the aerosolizable material transport element.

There has been also described an aerosol provision system comprising: a cartridge, and a body, wherein the body comprises a recess for releasably accommodating at least one surface of the cartridge, wherein the at least one surface of the cartridge is devoid of any fluid inlet for delivering fluid into the cartridge.

There has also been described an aerosol provision system comprising:
a cartridge comprising a mouthpiece; and
a body comprising a recess for releasably accommodating at least one surface of the cartridge, wherein the body comprises a shroud which defines the recess, wherein an end of the shroud comprises at least one recessed portion, wherein each recessed portion is configured to align with an air inlet from the cartridge when the at least one surface of the cartridge is releasably accommodated in the recess;
wherein the mouthpiece is configured to be adjacent to the at least one recessed portion when the at least one surface of the cartridge is releasably accommodated in the recess.

There has also been described a cartridge for use in an aerosol provision system, wherein the cartridge comprises:
a first end surface which is devoid of any fluid inlet for delivering fluid into the cartridge;
a second end surface which is opposite the first end surface;
a plurality of side surfaces which extend between the first end surface and the second end surface, wherein the plurality of side surfaces comprises at least one air inlet for delivering air into the cartridge; and
a mouthpiece;
wherein each air inlet is located adjacent to the mouthpiece, and is located between the mouthpiece and the first end surface.

There has also been described an aerosol provision cartridge for use in an aerosol provision system comprising the cartridge and a body, wherein the cartridge comprises:
a first reservoir for containing aerosolizable material;
an exterior, thermally conductive, surface for receiving heat from a heating element located in the body, wherein the exterior surface is for vaporizing aerosolizable material from the first reservoir; and
a second reservoir for containing flavoring material, wherein the second reservoir is configured to receive vaporized aerosolizable material.

There has also been described an aerosol provision system 1 comprising an aerosolizable material transport element 34 for receiving aerosolizable material. The aerosolizable material transport element 34 comprises an aperture 60 extending through a thickness of the aerosolizable material transport element 34. The aerosol provision system 1 also comprises a conductive member 46, in the form of a conductive plate or a conductive foil, which is in contact with the aerosolizable material transport element 34, and comprising a thermally conductive surface 32B for receiving heat for transferring to the aerosolizable material transport element 34. The aerosolizable material transport element 34 is in contact with the conductive member 46 at a contact surface 48 from the conductive member 46, and the contact surface 48 is opposite the thermally conductive surface 32B. This arrangement allows for an efficient transfer of heat across the conductive member 46 to the aerosolizable material transport element 34.

There has also been described an aerosolizable material transport element 34, for use in an aerosol provision system 1, which comprises a length L extending between a first end 50 of the aerosolizable material transport element 34 and a second end 52 of the aerosolizable material transport element 34, and a first leg portion 54 extending from the first end 50, and a second leg portion 56 extending from the second end 52, with a central body portion 58 located between the first leg portion 54 and the second leg portion 56. The central body portion 58 comprises an aperture 60 extending through a thickness of the aerosolizable material transport element 34, and the aerosolizable material transport element 34 comprises at least one indented portion 66. At least, each indented portion 66 may serve to better prevent the aerosolizable material transport element 34 from moving in use, and each indented portion 66 along with the aperture 60 may help with the vaporization of aerosolizable material from the aerosolizable material transport element 34.

There has also been described an aerosol provision cartridge 10 comprising an aerosolizable material transport element 34 for receiving aerosolizable material. The aerosol provision cartridge 10 also comprises a first channel 38 for receiving air from an air inlet 20 of the cartridge 10; wherein the first channel 38 comprises at least one orifice 64, wherein each orifice 64 is adjacent the aerosolizable material transport element 34. The aerosolizable material transport element 34 comprises an indented portion 66, for each respective orifice 64 from the first channel 38, which is located adjacent its respective orifice 64 from the first channel 38. At least, each indented portion 66 may serve to better prevent the aerosolizable material transport element 34 from moving in use, and each indented portion 66 may help with the vaporization of aerosolizable material from the aerosolizable material transport element 34.

There has also been described an aerosol provision cartridge comprising an aerosolizable material transport element 34, for receiving aerosolizable material, which comprises a first leg portion 54 extending from a first end 50, and a second leg portion 56 extending from a second end 52. The aerosolizable material transport element 34 further comprises a central body portion 58 located between the first leg portion 54 and the second leg portion 56. The aerosol provision cartridge 10 further comprises a first channel 38 for receiving air from an air inlet 20 of the cartridge 10; wherein the first channel 38 comprises at least one orifice 64, wherein each orifice 64 is adjacent the central body portion of the aerosolizable material transport element 34. The relative location of each orifice 64 relative to the leg portions 54; 56 and the central body portion 58 of the aerosolizable material transport element 34 helps with the vaporization of aerosolizable material from the aerosolizable material transport element 34 in an efficient manner.

There has also been described an aerosol provision system 1 for forming a vapor from aerosolizable material, wherein the aerosol provision system comprises a cartridge 10 comprising aerosolizable material for vaporizing, and a body 100 for releasably accommodating the cartridge.

The cartridge is configured to be at least partially located in a recess/receptacle 102 of the body when the cartridge 10 is releasably accommodated by the cartridge 10.

The cartridge 10 may comprise a mouthpiece 22 for delivering vaporized aerosolizable material to the user of the aerosol provision system.

For helping to direct, and seal, vaporized aerosolizable material into the user's mouth from an orifice 39 at a first, potentially flat, end 16 of the mouthpiece 22, the mouthpiece may comprise an inclined side surface, wherein the inclined side surface extends between the first end 16 and a second end of the mouthpiece, wherein the inclined side surface is inclined towards the first end 16 of the mouthpiece (which may also be a first end 16 of the cartridge 10).

The inclined surface may in some instances be an elliptical, and/or annular, inclined side surface, in so far as the side surface may in some instances extend around the entirety of a circumference (which need not necessarily be circular) of the mouthpiece (as can be seen in the embodiment of FIGS. 2A-2D for instance).

Such an inclined side surface, in some instances, may also be opaque to facilitate the user not being able to view the internal contents of the cartridge 10 in use.

The shape of any such provided cartridge 10 may be non-circular in so far as the cartridge may be configured to be at least partially located in the receptacle 102 of the body 100 in at least two different orientations. The two different orientations may optionally comprise a first rotational position of the cartridge relative to the body; and a second rotational position of the cartridge relative to the body, such that the cartridge 10 can be inserted about two different rotational positions (potentially spaced 180 degrees apart from each other). In this way for instance, the cartridge and/or aspects therefrom (such as the mouthpiece, or the inclined side surface) in some instances (as shown in the embodiments of the Figures) may comprise two, or at least two, orders of rotational symmetry.

For also improving the consistency and symmetry of the fit of the mouthpiece in the user's mouth in use, in accordance with some embodiments as well, the mouthpiece and/or any provided inclined side surface therefrom, may comprise at least one, or in some embodiments at least two, lines of symmetry. These lines of symmetry are shown in the embodiment of FIGS. 2A-2B as being perpendicular to each other (where one line of symmetry is parallel to the direction ‘L’ shown in FIG. 2D), and the other is perpendicular to this first line of symmetry (i.e. perpendicular to the direction ‘L’ shown in FIG. 2D). Where any such line(s) of symmetry are provided, in accordance with some embodiments these may be each perpendicular to a longitudinal axis of the cartridge (which is an axis in the embodiment of FIGS. 2A-2B extending between the two ends of the cartridge, and which is parallel to both of the first and second channels 38; 40, and/or which passes through the centre/central axis of the second channel 40 and/or the any provided second reservoir 36 and/or orifice 39).

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of any of the dependent claims, or clauses from any of the herein disclosed sets of clauses, may be combined with any of the features of the independent claims or clauses in combinations other than those explicitly set out in the claims/clauses (e.g. any of the features from the further set of consistory set of clauses may be combined with any of other recited clause/claim sets, purely as an illustrative example). The disclosure may include other inventions not presently claimed, but which may be claimed in future. For instance, although the present disclosure has been described with reference to a “liquid” or “fluid” in the consumable part/aerosol provision system, it will be appreciated that this liquid or fluid may be replaced with any aerosolizable material. Equally, where an aerosolizable material is used, it will be appreciated that in some embodiments this aerosolizable material may comprise a liquid or fluid.

With respect to the vaporizer 32, and as explained previously, the vaporizer 32 herein described may take a variety of different forms. In that respect, although the vaporizer 32 herein described has been principally described as being a vaporizer 32 which is at least partially located in the body and at least partially located in the cartridge, in accordance with some embodiments it is envisaged that any provided vaporizer may be exclusively located in the cartridge 10, or exclusively the body 100. In that respect as well, although the vaporizer 32 herein described has been described in some embodiments as comprising a heater/heating element, it will be appreciated that in some other embodiments the vaporizer may be capable of generating a vapor/aerosol from the aerosolizable material without applying heat thereto, for example via one or more of vibrational, mechanical, pressurisation or electrostatic means as described previously.

With respect to the provided embodiments which employ a body 100 which can releasably accommodate, and/or be releasably attached to, a cartridge 10, other aspects of the present disclosure may appreciably also relate to how such a cartridge 10 may be effectively accommodated by the body in a secure/compact manner, such as per the arrangements shown in the embodiments of the Figures. In that respect therefore, it may be appreciated the present disclosure may thus also provide for the embodiments as described in the final set of clauses at the end of the description. With respect to these features, it may be appreciated that these may thus allow for a two-part aerosol provision system, using the features herein described, in which the cartridge is securely held by the body-potentially via a friction-fit.

Finally as well, whilst a number of the features herein described have been described with reference to embodiments of aerosol provision system which are provided as part of a body 100 which can releasably accommodate, and/or be releasably attached to, a cartridge 10, it will be appreciated that in some embodiments, any of the herein described features from the cartridge 10 and/or the body 100 may be integrated into an aerosol provision system 1 which does not comprise such a catridge10/body 100 configuration.

### First Set of Clauses

1. An aerosolizable material transport element for use in an aerosol provision system,
wherein the aerosolizable material transport element comprises a length extending between a first end of the aerosolizable material transport element and a second end of the aerosolizable material transport element,
wherein the aerosolizable material transport element comprises a first leg portion extending from the first end, and a second leg portion extending from the second end, and a central body portion located between the first leg portion and the second leg portion;
wherein the central body portion comprises an aperture extending through a thickness of the aerosolizable material transport element; and
wherein the aerosolizable material transport element comprises at least one indented portion.

2. An aerosolizable material transport element according to clause 1, wherein the aperture extends through a thickness of the aerosolizable material transport element in a direction which is perpendicular to the length of the aerosolizable material transport element.

3. An aerosolizable material transport element according to clause 1 or 2, wherein the aperture is cylindrical.

4. An aerosolizable material transport element according to any preceding clause, wherein the cross sectional area of the aerosolizable material transport element changes along the length of the aerosolizable material transport element.

5. An aerosolizable material transport element according to any preceding clause, wherein the central body portion comprises the at least one indented portion.

6. An aerosolizable material transport element according to any preceding clause, wherein the at least one indented portion comprises a first indented portion located on a first side of the aerosolizable material transport element, and a second indented portion located on a second side of the aerosolizable material transport element.

7. An aerosolizable material transport element according to clause 6, wherein the first side of the aerosolizable material transport element is opposite the second side of the aerosolizable material transport element.

8. An aerosolizable material transport element according to clause 6 or 7, wherein the first side and the second side are sides of the central body portion.

9. An aerosol provision system comprising the aerosolizable material transport element according to any preceding clause.

10. An aerosol provision system according to clause 9, further comprising a first reservoir for containing aerosolizable material for delivery to the aerosolizable material transport element.

11. An aerosol provision system according to clause 10, wherein each leg portion from the aerosolizable material transport element is in fluid communication with the first reservoir for receiving aerosolizable material from the first reservoir.

12. An aerosol provision system according to clause 10 or 11, further comprising a vaporizer for vaporizing aerosolizable material, from the aerosolizable material transport element, which is configured to be delivered to the aerosolizable material transport element from the first reservoir.

13. An aerosol provision system according to clause 12, wherein the aerosol provision system comprises a second reservoir for containing flavoring material, wherein the second reservoir is configured to receive vaporized aerosolizable material from the vaporizer.

14 An aerosol provision system according to clause 13, wherein the second reservoir contains the flavoring material.

15. An aerosol provision system according to any of clauses 13-14, wherein the flavoring material comprises at least one of tobacco and/or nicotine.

16. An aerosol provision system according to any of clauses 12-15, wherein the aerosol provision system comprises:
a first channel for receiving air from an air inlet of the aerosol provision system; and
a second channel, which is located downstream of the first channel, and which is configured to receive vaporized aerosolizable material from the vaporizer.

17. An aerosol provision system according to clause 16, wherein the first channel comprises at least one orifice in fluid communication with the second channel, wherein each orifice is adjacent the aerosolizable material transport element.

18. An aerosol provision system according to clause 17, wherein each orifice is adjacent the central body portion of the aerosolizable material transport element.

19. An aerosol provision system according to any of clauses 17-18, wherein the at least one indented portion comprises a respective indented portion, for each orifice from the at least one orifice, which is located adjacent a respective orifice from the at least one orifice.

20. An aerosol provision system according to any of clauses 17-19, wherein each orifice extends in a direction which is orthogonal to the length of the aerosolizable material transport element.

21. An aerosol provision system according to any of clauses 16-20, wherein the first channel is parallel to the second channel.

22. An aerosol provision system according to any of clauses 16-21, wherein the first channel is located outside of the second channel.

23. An aerosol provision system according to any of clauses 16-22, wherein air is configured to flow in a first direction along the first channel, and vaporized aerosolizable material from the vaporizer is configured to flow in a second direction along the second channel, wherein the second direction is opposite to the first direction.

24. An aerosol provision system according to clause 23, when further dependent on any of clauses 17-20, wherein each orifice extends in a direction between the first channel and the second channel, which is orthogonal to the first direction and the second direction.

25. An aerosol provision system according to any of clauses 16-24, wherein the aerosolizable material transport element is located at an end of the first channel and at an end of the second channel.

26. An aerosol provision system according to any of clauses 12-25, wherein the vaporizer comprises a heating element.

27. An aerosol provision system according to clause 26, further comprising a thermally conductive surface for receiving heat from the heating element, wherein the thermally conductive surface forms part of the vaporizer.

28. An aerosol provision system according to clause 27, wherein the thermally conductive surface forms part of a conductive member, wherein the aerosolizable material transport element is in contact with the conductive member.

29. An aerosol provision system according to clause 28, wherein the aerosolizable material transport element is in contact with the conductive member at a contact surface from the conductive member, wherein the contact surface is opposite the thermally conductive surface.

30. An aerosol provision system according to any of clauses 27-29, when further dependent on clauses 13 and 16, wherein the second channel is located between the second reservoir and the thermally conductive surface.

31. An aerosol provision system according to any of clauses 9-30, wherein the aerosol provision system further comprises a vaporizer for receiving aerosolizable material.

32. An aerosol provision system according to any of clauses 9-31, wherein the aerosol provision system comprises an aerosol provision cartridge.

33. An aerosol provision system according to any of clauses 9-31, further comprising: a body for releasably accommodating a cartridge, wherein the cartridge comprises the aerosolizable material transport element.

34. An aerosol provision system according to clause 33, when further dependent on clause 12 or 31, wherein the vaporizer is at least partially located in the body and at least partially located in the cartridge.

35. An aerosol provision system according to clause 34, wherein the vaporizer comprises: a heating element, wherein the heating element is located in the body; and a conductive member, located in the cartridge, comprising a thermally conductive surface for receiving heat from the heating element.

36. An aerosol provision system according to clause 35, wherein the aerosolizable material transport element is in contact with the conductive member.

37. A method of forming a vapor using an aerosolizable material transport element, wherein the method comprises:
receiving aerosolizable material at a first end and a second end of the aerosolizable material transport element;
passing air over at least one indented portion of the aerosolizable material transport element; and
forming a vapor, from the aerosolizable material and the air, at an aperture from a central body portion of the aerosolizable material transport element, wherein the central body portion is located between the first end and the second end.

### Second Set of Clauses

1. An aerosol provision cartridge comprising:
an aerosolizable material transport element for receiving aerosolizable material;
a first channel for receiving air from an air inlet of the cartridge; wherein the first channel comprises at least one orifice, wherein each orifice is adjacent the aerosolizable material transport element;
wherein the aerosolizable material transport element comprises an indented portion, for each respective orifice from the first channel, which is located adjacent its respective orifice from the first channel.

2. An aerosol provision cartridge according to clause 1, wherein the aerosolizable material transport element comprises:
a length extending between a first end of the aerosolizable material transport element and a second end of the aerosolizable material transport element;
a first leg portion extending from the first end, and a second leg portion extending from the second end, and a central body portion located between the first leg portion and the second leg portion;
wherein the central body portion comprises an aperture extending through a thickness of the aerosolizable material transport element.

3. An aerosol provision cartridge according to clause 2, wherein the aperture extends through a thickness of the aerosolizable material transport element in a direction which is perpendicular to the length of the aerosolizable material transport element.

4. An aerosol provision cartridge according to any of clauses 2-3, wherein the aperture is cylindrical.

5. An aerosol provision cartridge according to any of clauses 2-4, wherein the central body portion comprises each indented portion.

6. An aerosol provision cartridge according to any preceding clause, wherein the aerosolizable material transport element comprises a first indented portion located on a first side of the aerosolizable material transport element, and a second indented portion located on a second side of the aerosolizable material transport element.

7. An aerosol provision cartridge according to clause 6, wherein the first side of the aerosolizable material transport element is opposite the second side of the aerosolizable material transport element.

8. An aerosol provision cartridge according to clause 6 or 7, when further dependent on clause 2, wherein the first side and the second side are sides of the central body portion.

9. An aerosol provision cartridge according to any preceding clause, wherein the cross sectional area of the aerosolizable material transport element changes along the length of the aerosolizable material transport element.

10. An aerosol provision cartridge according to any preceding clause, further comprising a first reservoir for containing aerosolizable material for delivery to the aerosolizable material transport element.

11. An aerosol provision cartridge according to clause 10, when further dependent on clause 2, wherein each leg portion from the aerosolizable material transport element is in fluid communication with the first reservoir for receiving aerosolizable material from the first reservoir.

12. An aerosol provision cartridge according to clause 10 or 11, further comprising a vaporizer for vaporizing aerosolizable material, from the aerosolizable material transport element, which is configured to be delivered to the aerosolizable material transport element from the first reservoir.

13. An aerosol provision cartridge according to clause 12, wherein the aerosol provision cartridge comprises a second reservoir for containing flavoring material, wherein the second reservoir is configured to receive vaporized aerosolizable material from the vaporizer.

14 An aerosol provision cartridge according to clause 13, wherein the second reservoir contains the flavoring material.

15. An aerosol provision cartridge according to any of clauses 13-14, wherein the flavoring material comprises at least one of tobacco and/or nicotine.

16. An aerosol provision cartridge according to any of clauses 12-15, wherein the aerosol provision cartridge further comprises a second channel, which is located downstream of the first channel, and which is configured to receive vaporized aerosolizable material from the vaporizer.

17. An aerosol provision cartridge according to clause 16, wherein each orifice is in fluid communication with the second channel.

18. An aerosol provision cartridge according to any of clauses 16-17, wherein the first channel is parallel to the second channel.

19. An aerosol provision cartridge according to any of clauses 16-18, wherein the first channel is located outside of the second channel.

20. An aerosol provision cartridge according to any of clauses 16-19, wherein air is configured to flow in a first direction along the first channel, and vaporized aerosolizable material from the vaporizer is configured to flow in a second direction along the second channel, wherein the second direction is opposite to the first direction.

21. An aerosol provision cartridge according to clause 20, wherein each orifice extends in a direction between the first channel and the second channel, which is orthogonal to the first direction and the second direction.

22. An aerosol provision cartridge according to any of clauses 16-21, wherein the aerosolizable material transport element is located at an end of the first channel and at an end of the second channel.

23. An aerosol provision cartridge according to any of clauses 12-22, wherein the vaporizer comprises a heating element.

24. An aerosol provision cartridge according to any of clauses 12-23, wherein the vaporizer comprises a thermally conductive surface, wherein the thermally conductive surface forms part of a conductive member, wherein the aerosolizable material transport element is in contact with the conductive member.

25. An aerosol provision cartridge according to clause 24, wherein the aerosolizable material transport element is in contact with the conductive member at a contact surface from the conductive member, wherein the contact surface is opposite the thermally conductive surface.

26. An aerosol provision cartridge according to any of clauses 24-25, when further dependent on clauses 13 and 16, wherein the second channel is located between the second reservoir and the thermally conductive surface.

27. An aerosol provision cartridge according to any preceding clause, wherein each orifice extends in a direction which is orthogonal to a length of the aerosolizable material transport element.

28. An aerosol provision cartridge according to any preceding clause, wherein the aerosol provision cartridge further comprises a vaporizer for receiving aerosolizable material.

29. An aerosol provision system comprising:
an aerosolizable material transport element for receiving aerosolizable material;
a first channel for receiving air from an air inlet of the aerosol provision system; wherein the first channel comprises at least one orifice, wherein each orifice is adjacent the aerosolizable material transport element;
wherein the aerosolizable material transport element comprises an indented portion, for each respective orifice from the first channel, which is located adjacent its respective orifice from the first channel.

30. An aerosol provision system according to clause 29, further comprising:
a body for releasably accommodating a cartridge,
wherein the cartridge comprises the aerosolizable material transport element and the first channel.

31. An aerosol provision system according to clause 30, further comprising a vaporizer, wherein the vaporizer comprises:
a heating element, wherein the heating element is located in the body; and
a conductive member, located in the cartridge, comprising a thermally conductive surface for receiving heat from the heating element.

32. An aerosol provision system according to clause 30, wherein the aerosolizable material transport element is in contact with the conductive member.

33. A method of forming a vapor, wherein the method comprises:
receiving aerosolizable material in an aerosolizable material transport element;
receiving air at an air inlet;
passing the air, from the air inlet, through a first channel to at least one orifice, to an aerosolizable material transport element, wherein the air passes through the at least one orifice and over at least one indented portion from the aerosolizable material transport element; and
forming a vapor, at the aerosolizable material transport element, from the aerosolizable material and the air;
wherein each orifice is adjacent the aerosolizable material transport element.

### Third Set of Clauses

1. An aerosol provision cartridge comprising:
an aerosolizable material transport element for receiving aerosolizable material, wherein the aerosolizable material transport element comprises a first leg portion extending from a first end of the aerosolizable material transport element, and a second leg portion extending from a second end of the aerosolizable material transport element, and a central body portion located between the first leg portion and the second leg portion;
a first channel for receiving air from an air inlet of the cartridge; wherein the first channel comprises at least one orifice, wherein each orifice is adjacent the central body portion of the aerosolizable material transport element.

2. An aerosol provision cartridge according to clause 1, wherein the aerosolizable material transport element comprises an indented portion, for each respective orifice from the first channel, which is located adjacent its respective orifice from the first channel.

3. An aerosol provision cartridge according to clause 2, wherein the aerosolizable material transport element comprises a first indented portion located on a first side of the aerosolizable material transport element, and a second indented portion located on a second side of the aerosolizable material transport element.

4. An aerosol provision cartridge according to clause 3, wherein the first side of the aerosolizable material transport element is opposite the second side of the aerosolizable material transport element.

5. An aerosol provision cartridge according to any preceding clause, further comprising a first reservoir for containing aerosolizable material for delivery to the aerosolizable material transport element.

6. An aerosol provision cartridge according to clause 5, wherein each leg portion from the aerosolizable material transport element is in fluid communication with the first reservoir for receiving aerosolizable material from the first reservoir.

7. An aerosol provision cartridge according to clause 5 or 6, further comprising a vaporizer for vaporizing aerosolizable material, from the aerosolizable material transport element, which is configured to be delivered to the aerosolizable material transport element from the first reservoir.

8. An aerosol provision cartridge according to clause 7, wherein the aerosol provision cartridge comprises a second reservoir for containing flavoring material, wherein the second reservoir is configured to receive vaporized aerosolizable material from the vaporizer.

9 An aerosol provision cartridge according to clause 8, wherein the second reservoir contains the flavoring material.

10. An aerosol provision cartridge according to any of clauses 8-9, wherein the flavoring material comprises at least one of tobacco and/or nicotine.

11. An aerosol provision cartridge according to any of clauses 7-10, wherein the aerosol provision cartridge further comprises a second channel, which is located downstream of the first channel, and which is configured to receive vaporized aerosolizable material from the vaporizer.

12. An aerosol provision cartridge according to clause 11, wherein each orifice is in fluid communication with the second channel.

13. An aerosol provision cartridge according to any of clauses 11-12, wherein the first channel is parallel to the second channel.

14. An aerosol provision cartridge according to any of clauses 11-13, wherein the first channel is located outside of the second channel.

15. An aerosol provision cartridge according to any of clauses 11-14, wherein air is configured to flow in a first direction along the first channel, and vaporized aerosolizable material from the vaporizer is configured to flow in a second direction along the second channel, wherein the second direction is opposite to the first direction.

16. An aerosol provision cartridge according to clause 15, wherein each orifice extends in a direction between the first channel and the second channel, which is orthogonal to the first direction and the second direction.

17. An aerosol provision cartridge according to any of clauses 11-16, wherein the aerosolizable material transport element is located at an end of the first channel and at an end of the second channel.

18. An aerosol provision cartridge according to any of clauses 7-17, wherein the vaporizer comprises a heating element.

19. An aerosol provision cartridge according to any of clauses 7-18, wherein the vaporizer comprises a thermally conductive surface, wherein the thermally conductive surface forms part of a conductive member, wherein the aerosolizable material transport element is in contact with the conductive member.

20. An aerosol provision cartridge according to clause 19, wherein the aerosolizable material transport element is in contact with the conductive member at a contact surface from the conductive member, wherein the contact surface is opposite the thermally conductive surface.

21. An aerosol provision cartridge according to any of clauses 19-20, when further dependent on clauses 8 and 11, wherein the second channel is located between the second reservoir and the thermally conductive surface.

22. An aerosol provision cartridge according to any preceding clause, wherein the central body portion comprises an aperture extending through a thickness of the aerosolizable material transport element.

23. An aerosol provision cartridge according to clause 22, wherein the aperture is cylindrical.

24. An aerosol provision cartridge according to any preceding clause, wherein the aerosolizable material transport element comprises a length extending between the first end of the aerosolizable material transport element and the second end of the aerosolizable material transport element.

25. An aerosol provision cartridge according to clause 24, when further dependent on clause 22 or 23, wherein the cross sectional area of the aerosolizable material transport element changes along the length of the aerosolizable material transport element.

26. An aerosol provision cartridge according to clause 24 or 25, when further dependent on clause 22 or 23, wherein the aperture extends through a thickness of the aerosolizable material transport element in a direction which is perpendicular to the length of the aerosolizable material transport element.

27. An aerosol provision cartridge according to any preceding clause, wherein each orifice extends in a direction which is orthogonal to a length of the aerosolizable material transport element.

28. An aerosol provision cartridge according to any preceding clause, wherein the aerosol provision cartridge further comprises a vaporizer for receiving aerosolizable material.

29. An aerosol provision system comprising:
an aerosolizable material transport element for receiving aerosolizable material; wherein the aerosolizable material transport element comprises a first leg portion extending from a first end of the aerosolizable material transport element, and a second leg portion extending from a second end of the aerosolizable material transport element, and a central body portion located between the first leg portion and the second leg portion;
a first channel for receiving air from an air inlet of the aerosol provision system; wherein the first channel comprises at least one orifice, wherein each orifice is adjacent the central body portion of the aerosolizable material transport element.

30. An aerosol provision system according to clause 29, further comprising:
a body for releasably accommodating a cartridge,
wherein the cartridge comprises the aerosolizable material transport element and the first channel.

31. An aerosol provision system according to clause 30, further comprising a vaporizer, wherein the vaporizer comprises:
a heating element, wherein the heating element is located in the body; and
a conductive member, located in the cartridge, comprising a thermally conductive surface for receiving heat from the heating element.

32. An aerosol provision system according to clause 31, wherein the aerosolizable material transport element is in contact with the conductive member.

33. A method of forming a vapor, wherein the method comprises:
receiving aerosolizable material at a first portion and a second portion of an aerosolizable material transport element;
receiving air at an air inlet;
passing the air, from the air inlet, through a first channel to at least one orifice, to the aerosolizable material transport element, wherein the air passes through the at least one orifice and over a central body portion from the aerosolizable material transport element, wherein the central body portion is located between the first portion and the second portion; and
forming a vapor, at the central body portion from the aerosolizable material transport element, from the aerosolizable material and the air;
wherein each orifice is adjacent the central body portion of the aerosolizable material transport element.

### Consistory Set of Clauses

1. An aerosol provision system comprising:
an aerosolizable material transport element for receiving aerosolizable material.

2. An aerosol provision system according to clauseclause 1, wherein the aerosolizable material transport element comprises an aperture extending through a thickness of the aerosolizable material transport element.

3. An aerosol provision system according to any preceding clause, further comprising:
a conductive member, in contact with the aerosolizable material transport element, and comprising a thermally conductive surface for receiving heat for transferring to the aerosolizable material transport element.

4. An aerosol provision system according to clause 3, wherein the aerosolizable material transport element is in contact with the conductive member at a contact surface from the conductive member.

5. An aerosol provision system according to clause 4, wherein the contact surface is opposite the thermally conductive surface.

6. An aerosol provision system according to any of clauses 3-5, wherein the conductive member comprises a conductive plate or a conductive foil.

7. An aerosol provision system according to any of clauses 3-6, wherein the conductive member comprises a thickness of no more than 5 mm.

8. An aerosol provision system according to any of clauses 3-7, wherein the conductive member comprises a thickness of at least 0.5 mm.

9. An aerosol provision system according to any of clauses 3-8, wherein the conductive member comprises a thickness of at least 1 mm.

10. An aerosol provision system according to any of clauses 3-9, wherein the conductive member comprises a thickness of between 1 mm and 5 mm.

11. An aerosol provision system according to any preceding clause, when further dependent on clauses 2 and 4 at least, wherein the aperture extends in a direction which is perpendicular to at least one of the contact surface and the thermally conductive surface.

15. An aerosol provision system according to any preceding clause, when further dependent on clauses 2 and 4 at least, wherein the aerosolizable material transport element comprises a flat surface which contacts the contact surface from the conductive member.

16. An aerosol provision system according to any preceding clause, when further dependent on clause 4 at least, wherein the contact surface is parallel to the thermally conductive surface.

17. An aerosol provision system according to any preceding clause, wherein the aerosolizable material transport element comprises at least one leg portion for receiving aerosolizable material to be vaporized.

18. An aerosol provision system according to clause 17,
wherein the aerosolizable material transport element comprises a length extending between a first end of the aerosolizable material transport element and a second end of the aerosolizable material transport element,
wherein the at least one leg portion comprises a first leg portion extending from the first end, and a second leg portion extending from the second end.

19. An aerosol provision system according to clause 18, wherein the aerosolizable material transport element further comprises a central body portion located between the first leg portion and the second leg portion.

20. An aerosol provision system according to clause 19, when further dependent on clause 2 at least, wherein the central body portion comprises the aperture.

21. An aerosol provision system according to any preceding clause, when further dependent on clause 2 at least, wherein the aperture extends through a thickness of the aerosolizable material transport element in a direction which is perpendicular to the length of the aerosolizable material transport element.

22. An aerosolizable material transport element according to any preceding clause, wherein the cross sectional area of the aerosolizable material transport element changes along the length of the aerosolizable material transport element.

23. An aerosol provision system according to any preceding clause, when further dependent on clause 2 at least, wherein the aperture is cylindrical.

24. An aerosolizable material transport element according to any preceding clause, wherein the aerosolizable material transport element comprises at least one indented portion.

25. An aerosolizable material transport element according to clause 24, wherein the at least one indented portion comprises a first indented portion located on a first side of the aerosolizable material transport element, and a second indented portion located on a second side of the aerosolizable material transport element.

26. An aerosolizable material transport element according to clause 25, wherein the first side of the aerosolizable material transport element is opposite the second side of the aerosolizable material transport element.

27. An aerosolizable material transport element according to clause 25 or 26, when further dependent on clause 19, wherein the first side and the second side are sides of the central body portion.

28. An aerosolizable material transport element according to any of clauses 24-27, when further dependent on clause 19, wherein the central body portion comprises the at least one indented portion.

29. An aerosol provision system according to any preceding clause, further comprising a first reservoir for containing aerosolizable material for delivery to the aerosolizable material transport element.

30. An aerosol provision system according to clause 29, when further dependent on clause 17, wherein each leg portion from the aerosolizable material transport element is in fluid communication with the first reservoir for receiving aerosolizable material from the first reservoir.

31. An aerosol provision system according to any preceding clause, wherein the aerosol provision system comprises a second reservoir for containing flavoring material, wherein the second reservoir is configured to receive vaporized aerosolizable material from the aerosolizable material transport element.

32 An aerosol provision system according to clause 31, wherein the second reservoir contains the flavoring material.

33. An aerosol provision system according to any of clauses 31-32, wherein the flavoring material comprises at least one of tobacco and/or nicotine.

34. An aerosol provision system according to any preceding clause, wherein the aerosol provision system further comprises:
a first channel for receiving air from an air inlet of the aerosol provision system.

35. An aerosol provision system according to clause 34, wherein the aerosol provision system further comprises:
a second channel, which is located downstream of the first channel, and which is configured to receive vaporized aerosolizable material from the aerosolizable material transport element.

36. An aerosol provision system according to clause 35, wherein the first channel comprises at least one orifice in fluid communication with the second channel, wherein each orifice is adjacent the aerosolizable material transport element.

37. An aerosol provision system according to clause 36, wherein each orifice is adjacent a central body portion of the aerosolizable material transport element.

39. An aerosol provision system according to any of clauses 36-37, when further dependent on clause 24, wherein the at least one indented portion comprises a respective indented portion, for each orifice from the at least one orifice, which is located adjacent a respective orifice from the at least one orifice.

40. An aerosol provision system according to any preceding clause, when further dependent on clause 3 at least, further comprising a heating element for delivering heat to the thermally conductive surface from the conductive member.

41. An aerosol provision system according to any preceding clause, wherein the aerosol provision system comprises an aerosol provision cartridge.

42. An aerosol provision system according to any preceding clause, further comprising:
a body for releasably accommodating a cartridge,
wherein the cartridge comprises the aerosolizable material transport element.

43. An aerosol provision system according to clause 41 or 42, when further dependent on clause 3, wherein the cartridge comprises the conductive member.

43. An aerosol provision system according to clause 42, when further dependent on clause 40 at least, wherein the heating element is located in the body.

44. An aerosol provision system according to any preceding clause, when further dependent on clause 41 or 42 at least, wherein the conductive member defines an outer surface of the cartridge.

45. An aerosol provision system according to any preceding clause, when further dependent on clause 41 or 42 at least, wherein the conductive member defines an exposed surface of the cartridge.

46. An aerosol provision system according to any preceding clause, when further dependent on clause 41 or 42 at least, wherein the conductive member is located at a first, or base, end the cartridge.

47. An aerosol provision system according to any preceding clause, when further dependent on clause 42 at least, wherein the conductive member is configured to contact a portion of the body when the cartridge is releasably accommodated by the cartridge.

48. An aerosol provision system according to any preceding clause, when further dependent on clause 42 at least, wherein the conductive member is configured to be located in a receptacle of the body when the cartridge is releasably accommodated by the cartridge.

49. An aerosol provision system according to any preceding clause, when further dependent on clause 41 at least, wherein the cartridge comprises a mouthpiece for delivering vaporized aerosolizable material to a user of the aerosol provision system.

50. An aerosol provision system according to clause 49, wherein the mouthpiece comprises a first end comprising an orifice for delivering the vaporized aerosolizable material to the user of the aerosol provision system.

51. An aerosol provision system according to clause 50, wherein the first end is flat.

52. An aerosol provision system according to clause 50 or 51, wherein the orifice is elongate.

53. An aerosol provision system according to any of clauses 49-52, wherein the mouthpiece comprises a second end, opposite the first end.

54. An aerosol provision system according to clause 53, wherein the second end is wider than the first end of the mouthpiece.

55. An aerosol provision system according to clause 53 or 54, wherein the cartridge is configured to be at least partially located in a receptacle of the body when the cartridge is releasably accommodated by the cartridge, wherein the second end of the mouthpiece is configured to engage with an end of the receptacle when the cartridge is releasably accommodated by the cartridge.

56. An aerosol provision system according to any preceding clause, when further dependent on clause 50 at least, wherein the first end of the mouthpiece is elongate.

57. A method of forming a vapor using an aerosolizable material transport element, wherein the method comprises:
receiving aerosolizable material in the aerosolizable material transport element;
forming a vapor from the aerosolizable material, at the aerosolizable material transport element.

58. A method according to clause 57, wherein the method further comprises:
receiving heat at a thermally conductive surface from a conductive member, wherein the conductive member comprises a conductive plate or a conductive foil;
transferring the heat from the conductive member to the aerosolizable material transport which is in contact with the conductive member; and
forming the vapor, from the heat transferred to the aerosolizable material transport, and from the aerosolizable material, at the aerosolizable material transport element.

### Further Consistory Set of Clauses

1. An aerosol provision system for forming a vapor from aerosolizable material, wherein the aerosol provision system comprises:
a cartridge comprising aerosolizable material for vaporizing; and
a body for releasably accommodating the cartridge.

2. An aerosol provision system according to clause 1, further comprising a vaporizer for vaporizing the aerosolizable material to form the vapor.

3. An aerosol provision system according to clause 2, wherein the cartridge comprises the vaporizer.

4. An aerosol provision system according to any preceding clause, wherein the cartridge comprises a conductive member comprising a thermally conductive surface for receiving heat for forming the vapor.

5. An aerosol provision system for generating a vapor of aerosolizbale material according to clause 4, wherein the conductive member defines an outer surface of the cartridge.

6. An aerosol provision system according to clause 4 or 5, wherein the conductive member defines an exposed surface of the cartridge.

7. An aerosol provision system according to any of clauses 4-6, wherein the conductive member is located at a first, or base, end the cartridge.

8. An aerosol provision system according to any of clauses 4-7, wherein the conductive member is configured to contact a portion of the body when the cartridge is releasably accommodated by the cartridge.

9. An aerosol provision system according to any preceding clause, wherein the cartridge is configured to be at least partially located in a receptacle of the body when the cartridge is releasably accommodated by the cartridge.

10. An aerosol provision system according to any preceding clause, wherein the cartridge comprises a mouthpiece for delivering vaporized aerosolizable material to a user of the aerosol provision system.

11. An aerosol provision system according to clause 10, wherein the mouthpiece comprises a first end comprising an orifice for delivering the vaporized aerosolizable material to the user of the aerosol provision system.

12. An aerosol provision system according to clause 11, wherein the first end is flat.

13. An aerosol provision system according to clause 11 or 12, wherein the orifice is elongate.

14. An aerosol provision system according to any of clauses 11-13, wherein the mouthpiece comprises a second end, opposite the first end.

15. An aerosol provision system according to clause 14, wherein the second end of the mouthpiece is wider than the first end of the mouthpiece.

16. An aerosol provision system according to clause 14 or 15, when further dependent on clause 9, wherein the second end of the mouthpiece is configured to engage with an end of the receptacle when the cartridge is releasably accommodated by the cartridge.

17. An aerosol provision system according to clause 16, wherein the first end of the mouthpiece defines a first end of the cartridge, and wherein the cartridge further comprises a second end which is located opposite the first end of the cartridge;
wherein the second end of the cartridge is configured to be located inside the receptacle when the cartridge is releasably accommodated by the cartridge; and
wherein the second end of the mouthpiece is wider than the first and second ends of the cartridge.

18. An aerosol provision system according to any preceding clause, when further dependent on clause 11 at least, wherein the first end of the mouthpiece is elongate.

19. An aerosol provision system according to any preceding clause, when further dependent on clause 9 at least, wherein the cartridge is configured to be at least partially located in a receptacle of the body in at least two different orientations, wherein the two different orientations may optionally comprise:
a first rotational position of the cartridge relative to the body; and
a second rotational position of the cartridge relative to the body.

20. An aerosol provision system according to any preceding clause, when further dependent on clause 9 at least, wherein the receptacle is non-circular.

21. An aerosol provision system according to any preceding clause, when further dependent on clause 9 at least, wherein the receptacle is elongate and/or comprises an elongate cross-section.

22. An aerosol provision system according to any preceding clause, further comprising a first reservoir in the cartridge for containing aerosolizable material for vaporizing.

23. An aerosol provision system according to clause 22, wherein the first reservoir is annular.

24. An aerosol provision system according to clause 22 or 23, when further dependent on clause 10 at least, wherein the first reservoir is at least partially surrounded by the mouthpiece.

25. An aerosol provision system according to any of clauses 22-24, when further dependent on clause 10 at least, wherein the first reservoir is at least partially embedded within the mouthpiece.

26. An aerosol provision system according to any preceding clause, further comprising a second channel configured to receive vaporized aerosolizable material.

27. An aerosol provision system according to clause 26, when further dependent on clause 22 at least, wherein the first reservoir at least partially surrounds the second channel.

28. An aerosol provision system according to clause 26 or 27, when further dependent on clause 11 at least, wherein the second channel is configured to deliver the vaporized aerosolizable material to the orifice of the mouthpiece.

29. An aerosol provision system according to clause 28, wherein the second channel terminates at the orifice.

30. An aerosol provision system according to any of clause 26-29, when further dependent on clause 2, wherein the second channel is configured to receive vaporized aerosolizable material from the vaporizer.

31. An aerosol provision system according to any preceding clause, wherein the cartridge comprises a first channel for receiving air from an air inlet(s) of the cartridge.

32. An aerosol provision system according to clause 31, when further dependent on clause 26, wherein the second channel is located downstream of the first channel.

33. An aerosol provision system according to any preceding clause, when further dependent on clause 14, wherein the mouthpiece comprises an inclined side surface, wherein the inclined side surface extends between the first end and the second end of the mouthpiece, wherein the inclined side surface is inclined towards the first end of the mouthpiece.

34. An aerosol provision system according to preceding clause, wherein the cartridge is configured to be at least partially located in the receptacle via a friction-fit.

35. An aerosol provision system according to preceding clause, when further dependent on clause 22, wherein the aerosolizable material comprises a solid aerosolizable material.

36. An aerosol provision system according to preceding clause, when further dependent on clause 22, wherein the aerosolizable material comprises a liquid aerosolizable material.

37. An aerosol provision system according to preceding clause, when further dependent on clause 22, wherein the aerosolizable material comprises tobacco.

38. An aerosol provision system according to preceding clause, when further dependent on clause 22, wherein the aerosolizable material comprises nicotine.

39. An aerosol provision system according to preceding clause, when further dependent on clause 22, wherein the aerosolizable material is nicotine-free.

40. An aerosol provision system according to preceding clause, when further dependent on clause 10, wherein the mouthpiece comprises an opaque outer surface.

42. An aerosol provision system according to preceding clause, when further dependent on clause 33, wherein the inclined side surface is opaque.

43. An aerosol provision system according to preceding clause, when further dependent on clause 33, wherein the inclined side surface is black.

44. An aerosol provision system according to preceding clause, wherein the cartridge is configured to be disposable and/or single-use.

45. An aerosol provision system according to preceding clause, wherein the cartridge comprises a conductive surface.

46. An aerosol provision system according to preceding clause, when further dependent on clause 33, wherein the inclined surface is an elliptical, or annular, inclined side surface.

47. An aerosol provision system according to preceding clause, when further dependent on clause 33, wherein the inclined surface extends around the entirety of a circumference of the mouthpiece.

48. An aerosol provision system according to preceding clause, when further dependent on clause 10, wherein the mouthpiece comprises two orders of rotational symmetry.

49. An aerosol provision system according to preceding clause, wherein the mouthpiece comprises two lines of symmetry.

50. An aerosol provision system according to clause 49, wherein the lines of symmetry are perpendicular to each other.

51. An aerosol provision system according to clause 49 or 50, wherein the lines of symmetry are perpendicular to a longitudinal axis of the cartridge which extends between a first end and second end of the cartridge.

52. An aerosol provision system according to clause 51, when further dependent on clause 26, wherein the longitudinal axis is parallel to the second channel.

53. An aerosol provision system according to clause 50 or 51, when further dependent on clause 31, wherein the longitudinal axis is parallel to the first channel.

54. A cartridge for use in an aerosol provision system for forming a vapor from aerosolizable material, wherein the cartridge comprises:
aerosolizable material for vaporizing.

55. A cartridge according to clause 54, further comprising any of the cartridge features as described in any of clauses 1-53.

56. An aerosol provision system for forming a vapor from aerosolizable material, wherein the aerosol provision system comprises:
a cartridge according to clause 54 or 55; and
a body for releasably accommodating the cartridge.

57. A method of forming a vapor from aerosolizable material using the aerosol provision system according to any of clauses 1-53 or 56.

58. A method of forming a vapor from aerosolizable material using the cartridge according to clause 54 or 55.

1. An aerosol provision system comprising:
an aerosolizable material transport element for receiving aerosolizable material, wherein the aerosolizable material transport element comprises an aperture extending through a thickness of the aerosolizable material transport element; and
a conductive member, in contact with the aerosolizable material transport element, and comprising a thermally conductive surface for receiving heat for transferring to the aerosolizable material transport element;
wherein the aerosolizable material transport element is in contact with the conductive member at a contact surface from the conductive member, wherein the contact surface is opposite the thermally conductive surface;
wherein the conductive member comprises a conductive plate or a conductive foil.

2. An aerosol provision system according to claim 1, wherein the conductive member comprises a thickness of no more than 5 mm.

3. An aerosol provision system according to claim 1, wherein the conductive member comprises a thickness of at least 0.5 mm.

4. An aerosol provision system according to claim 1, wherein the conductive member comprises a thickness of at least 1 mm.

5. An aerosol provision system according to claim 1, wherein the conductive member comprises a thickness of between 1 mm and 5 mm.

6. An aerosol provision system according to claim 1, wherein the aperture extends in a direction which is perpendicular to at least one of the contact surface and the thermally conductive surface.

7. An aerosol provision system according to claim 1, wherein the aerosolizable material transport element comprises a flat surface which contacts the contact surface from the conductive member.

8. An aerosol provision system according to claim 1, wherein the contact surface is parallel to the thermally conductive surface.

9. An aerosol provision system according to claim 1, wherein the aerosolizable material transport element comprises at least one leg portion for receiving aerosolizable material to be vaporized.

10. An aerosol provision system according to claim 9,
wherein the aerosolizable material transport element comprises a length extending between a first end of the aerosolizable material transport element and a second end of the aerosolizable material transport element,
wherein the at least one leg portion comprises a first leg portion extending from the first end, and a second leg portion extending from the second end.

11. An aerosol provision system according to claim 10, wherein the aerosolizable material transport element further comprises a central body portion located between the first leg portion and the second leg portion, wherein the central body portion comprises the aperture.

12. An aerosol provision system according to claim 10, wherein the aperture extends through a thickness of the aerosolizable material transport element in a direction which is perpendicular to the length of the aerosolizable material transport element.

13. An aerosolizable material transport element according to claim 10, wherein the cross sectional area of the aerosolizable material transport element changes along the length of the aerosolizable material transport element.

14. An aerosolizable material transport element according to claim 1, wherein the aperture is cylindrical.

15. An aerosolizable material transport element according to claim 1, wherein the aerosolizable material transport element comprises at least one indented portion.

16. An aerosolizable material transport element according to claim 15, wherein the at least one indented portion comprises a first indented portion located on a first side of the aerosolizable material transport element, and a second indented portion located on a second side of the aerosolizable material transport element.

17. An aerosolizable material transport element according to claim 16, wherein the first side of the aerosolizable material transport element is opposite the second side of the aerosolizable material transport element.

18. An aerosolizable material transport element according to claim 16, wherein the aerosolizable material transport element further comprises a central body portion located between the first leg portion and the second leg portion, wherein the central body portion comprises the aperture, wherein the first side and the second side are sides of the central body portion.

19. An aerosolizable material transport element according to claim 15, wherein the aerosolizable material transport element further comprises a central body portion located between the first leg portion and the second leg portion, wherein the central body portion comprises the aperture, wherein the central body portion comprises the at least one indented portion.

20. An aerosol provision system according to claim 1, further comprising a first reservoir for containing aerosolizable material for delivery to the aerosolizable material transport element.

21. An aerosol provision system according to claim 20, wherein the aerosolizable material transport element comprises at least one leg portion for receiving aerosolizable material to be vaporized, wherein each leg portion from the aerosolizable material transport element is in fluid communication with the first reservoir for receiving aerosolizable material from the first reservoir.

22. An aerosol provision system according to claim 1, wherein the aerosol provision system comprises a second reservoir for containing flavoring material, wherein the second reservoir is configured to receive vaporized aerosolizable material from the aerosolizable material transport element.

23. An aerosol provision system according to claim 22, wherein the second reservoir contains the flavoring material.

24. An aerosol provision system according to claim 22, wherein the flavoring material comprises at least one of tobacco and/or nicotine.

25. An aerosol provision system according to claim 1, wherein the aerosol provision system comprises:
a first channel for receiving air from an air inlet of the aerosol provision system; and
a second channel, which is located downstream of the first channel, and which is configured to receive vaporized aerosolizable material from the aerosolizable material transport element.

26. An aerosol provision system according to claim 25, wherein the first channel comprises at least one orifice in fluid communication with the second channel, wherein each orifice is adjacent the aerosolizable material transport element.

27. An aerosol provision system according to claim 26, wherein the aerosolizable material transport element further comprises a central body portion located between the first leg portion and the second leg portion, wherein the central body portion comprises the aperture, wherein each orifice is adjacent the central body portion of the aerosolizable aerosolisable material transport element.

28. An aerosol provision system according to claim 26, wherein the aerosolizable material transport element comprises at least one indented portion, wherein the at least one indented portion comprises a respective indented portion, for each orifice from the at least one orifice, which is located adjacent a respective orifice from the at least one orifice.

29. An aerosol provision system according to claim 1, further comprising a heating element for delivering heat to the thermally conductive surface from the conductive member.

30. An aerosol provision system according to claim 1, wherein the aerosol provision system comprises an aerosol provision cartridge.

31. An aerosol provision system according to claim 1, further comprising:
a body for releasably accommodating a cartridge,
wherein the cartridge comprises the aerosolizable material transport element and the conductive member.

32. An aerosol provision system according to claim 31, further comprising a heating element for delivering heat to the thermally conductive surface from the conductive member, wherein the heating element is located in the body.

33. An aerosol provision system according to claim 31, wherein the conductive member defines an outer surface of the cartridge.

34. An aerosol provision system according to claim 31, wherein the conductive member defines an exposed surface of the cartridge.

35. An aerosol provision system according to claim 31, wherein the conductive member is located at a first, or base, end the cartridge.

36. An aerosol provision system according to claim 31, wherein the conductive member is configured to contact a portion of the body when the cartridge is releasably accommodated by the cartridge.

37. An aerosol provision system according to claim 31, wherein the conductive member is configured to be located in a receptacle of the body when the cartridge is releasably accommodated by the cartridge.

38. An aerosol provision system according to claim 37, wherein the cartridge comprises a mouthpiece for delivering vaporized aerosolizable material to a user of the aerosol provision system, wherein the mouthpiece comprises an inclined side surface which extends between a first end and a second end of the mouthpiece, wherein the wherein the inclined side surface is inclined towards the first end of the mouthpiece;
wherein the mouthpiece comprises two orders of rotational symmetry; and,
wherein the mouthpiece comprises two lines of symmetry, wherein the lines of symmetry are perpendicular to each other;
wherein the second end of the mouthpiece is configured to engage with an end of the receptacle when the cartridge is releasably accommodated by the cartridge.

39. An aerosol provision system according to claim 38, wherein the inclined side surface is opaque.

40. An aerosol provision system according to claim 38, wherein the inclined side surface is elliptical.

41. An aerosol provision system according to claim 38, wherein the inclined side surface is annular.

42. A method of forming a vapor using an aerosolizable material transport element, wherein the method comprises:
receiving aerosolizable material in the aerosolizable material transport element;
receiving heat at a thermally conductive surface from a conductive member, wherein the conductive member comprises a conductive plate or a conductive foil;
transferring the heat from the conductive member to the aerosolizable material transport which is in contact with the conductive member, and
forming a vapor, from the heat transferred to the aerosolizable material transport, and from the aerosolizable material, at the aerosolizable material transport element.
